(19) United States
(12) Patent Application Publication
(10) Pub. No.: US 2007/0219911 A1
(43) Pub. Date: Sep. 20, 2007

(54) Apparatus and method for utilizing data block of right to decrypt content

(75) Inventor: Yasuhiko Abe, Saitama-ken (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/472,782

(22) Filed: Jun. 22, 2006

(30) Foreign Application Priority Data
Mar. 14, 2006 (JP) 2006-69070

(51) Int. Cl. G06Q 99/00

(52) U.S. Cl. 705/51

(57) ABSTRACT

Provided is a content decrypting apparatus given a bunch of secret keys and capable of decrypting a piece of content stored in a storage medium using a data block representing a right of decryption, including a communication circuit configured to request and receive the data block including a bunch of distributed keys and an allowed number of times of decryption, a first controller configured to decrypt a title key read from the storage medium with one of the distributed keys and one of the secret keys, and to decrypt the content with the decrypted title key, and a second controller configured, upon receiving a request for a data block transfer, to produce a secondary data block by copying the data block stored in the memory, and to move at least a portion of the allowed number of times of decryption to the secondary data block.

### CROSS REFERENCE TO RELATED APPLICATIONS

This application is based upon and claims the benefit of priority from the prior Japanese Patent Application No. 2006-069070 filed on Mar. 14, 2006; the entire contents of which are incorporated herein by reference.

### FIELD OF THE INVENTION

The present invention relates to an apparatus and a method for utilizing a data block representing a right to decrypt encrypted content.

### DESCRIPTION OF THE BACKGROUND

Due to progress of broadband networks and communication apparatus of high performance, content distribution via networks and via (removable) storage media becomes popular these days. As a piece of digital content may easily be copied and transferred without degrading quality, various activities like illegal copies, file exchanges, etc. making wrong use of the above feature of digital content bring about a lot of social problems. To deal with these problems, a plurality of protection methods to manage copyright on content distributed via networks is being developed, and a plurality of protection methods to prevent wrong use of content distributed via storage media is being developed, as mentioned in a following reference document: Hirota, K. and Sonehara, N., “Piracy protection in content distribution” (in Japanese), IEICE Journal, Vol. 88, No. 10, pp. 823-828, The Institute of Electronics, Information and Communication Engineers, October 2005.

One of these protection methods is named “Content Scrambling System (CSS)”, which is well known as an access control method to control apparatus and software for playing video content stored in digital video discs. In CSS, used are three kinds of 40-bit keys, a title key, a disc key and a master key. A piece of digital content is encrypted with the title key. The title key is encrypted with the disc key. The disc key is encrypted with the master key.

In CSS, a right content decrypting apparatus having a hidden master key may read an encrypted disc key, an encrypted title key and a piece of encrypted content from a storage medium, and may decrypt the encrypted disc key, the encrypted title key and the encrypted content one by one. A wrong content decrypting apparatus having no master key may not decrypt the disc key, the title key and the content one by one.

In 1999, however, an incident happened that a master key of CSS leaked out. Two new protection methods being robust for key leakage have thereby been developed and standardized. These are “Content Protection for Pre-recorded media (CPPM)” and “Content Protection for Recordable media (CPRM)”.

A main point of these protection methods will be briefly described as follows, e.g. with reference to a following reference document:

### Doi, N. and Sasaki, R., “A book on information security” (in Japanese), pp. 404-418, Kyoritsu Shuppan, Tokyo, July 2003 (ISBN 4-320-12070-1).

In CPPM and in CPRM, each recording apparatus configured to encrypt a piece of content is given a hidden set of 56-bit device keys (device key set), and so is each content decrypting apparatus configured to decrypt a piece of encrypted content. Each storage medium is given a 64-bit Media Identifier (Media ID) while being manufactured. Each storage medium is given a set of key management information called a Media Key Block (MKB). In a case where, e.g. a device key set of a recording apparatus (or instead, a content decrypting apparatus) has leaked out and has been applied to a wrong apparatus, each storage medium storing a piece of encrypted content released after the leakage is given an MKB configured to make the wrong apparatus ineffective, i.e. the wrong apparatus may not utilize the content released after the leakage.

The MKB contains a set of data regarding a Media Key. A right apparatus, i.e. being effective, may process the MKB using an individual device key set according to a given procedure to retrieve the Media Key. The right apparatus may use the Media Key for encryption and recording. The right apparatus may use the Media Key for decryption and playing.

Another apparatus given another device key set may retrieve the same Media Key from the same storage medium given the same MKB, as long as the apparatus is effective. A wrong apparatus, i.e. a recording apparatus, a content decrypting apparatus and so on, may not retrieve the Media Key and may neither record nor play the encrypted content.

Before a piece of encrypted content is recorded on a storage medium by a right recording apparatus, a retrieved Media Key and a Media ID are applied to a one-way function producing a Media Unique Key. A title key prepared apart is encrypted with the Media Unique Key. A piece of content is encrypted with the encrypted title key. The encrypted title key and the encrypted content are recorded on the storage medium.

Before a piece of encrypted content is read from a storage medium and decrypted to be played by a right content decrypting apparatus, a retrieved Media Key and a Media ID are applied to a one-way function producing a Media Unique Key. An encrypted title key read from the storage medium is decrypted with the Media Unique Key. The encrypted content read from the storage medium is decrypted with the decrypted title key.

Meanwhile, it is necessary to facilitate use and distribution of content as long as done properly. A method of renting a piece of encrypted content to a user (so called an electronic library) is disclosed in Japanese Patent Publication (Kokai), No. 2003-76805, by which a library server receives a request for key rental from a client terminal holding a piece of encrypted content, and determines if the request is approved. In a case of approval, the library server provides the client terminal with a key for decryption. The server repeats providing the client terminal with the key upon receiving another request before the rental expires.

A method of copyright protection is disclosed in Japanese Patent Publication (Kokai), No. 2005-25438, by which a library server controls how many pieces of content may be rented, and protects a copyright by renting the content after encryption. According to the method of copyright protection, the library server provides a key for encryption/decryption valid within a time limit. The library server may make the key ineffective after reaching the time limit, and may delete the key after reaching the time limit. After making the key ineffective, the library server may provide another key valid within an updated time limit, and thereby need not rent the content again.

### SUMMARY OF THE INVENTION

One aspect of the present invention is to provide a content decrypting apparatus capable of decrypting a piece of content stored in a storage medium using a data block representing a right to decrypt the content, including a communication circuit configured to request and receive the data block, and to receive a request for a data block transfer, the data block including a bunch of distributed keys and an allowed number of times of decryption, a memory configured to store a bunch of secret keys and the data block, a media reader configured to read a set of title keys and the content from the storage medium, a first controller configured, upon being instructed to decrypt the content, to decrypt one of the title keys with one of the distributed keys and one of the secret keys, and to decrypt the content with the decrypted title key, and a second controller configured, in response to the request for a data block transfer, to produce a secondary data block by copying the data block stored in the memory, to move at least a portion of the allowed number of times of decryption to the secondary data block, and to transfer the secondary data block via the communication circuit.

### BRIEF DESCRIPTION OF THE DRAWINGS

FIG. 1 is a conceptual diagram of a system including a content decrypting apparatus of a first embodiment of the present invention.

FIG. 2 is an external view of the content decrypting apparatus of the first embodiment of the present invention.

FIG. 3 is a bock diagram of the content decrypting apparatus of the first embodiment of the present invention.

FIG. 4 illustrates a breakdown of data being used for decryption and data transfer management of the first embodiment of the present invention.

FIG. 5 illustrates a process of encryption and recording of the first embodiment of the present invention.

FIG. 6 illustrates a process of decryption and related data exchange of the first embodiment of the present invention.

FIG. 7 illustrates a process of transferring an RTP data block and related data exchange of the first embodiment of the present invention.

FIG. 8 is a flow chart of a process of the first embodiment of the present invention.

FIG. 9 is a bock diagram of a content decrypting apparatus of a second embodiment of the present invention.

FIG. 10 illustrates a breakdown of data being used for decryption and data transfer management of the second embodiment of the present invention.

FIG. 11 illustrates a process of synchronizing a date and time between a server and the content decrypting apparatus of the second embodiment of the present invention.

FIG. 12 illustrates a process of decryption and related data exchange of the second embodiment of the present invention.

FIG. 13 illustrates a process of transferring an RTP data block and related data exchange of the second embodiment of the present invention.

FIG. 14 is a flow chart of a process of the second embodiment of the present invention.

FIG. 15 illustrates a breakdown of data being used for decryption and data transfer management of a third embodiment of the present invention.

FIG. 16 illustrates a process of synchronizing a date and time between a server and a content decrypting apparatus of the third embodiment of the present invention.

FIG. 17 illustrates a process of decryption and related data exchange of the third embodiment of the present invention.

FIG. 18 illustrates a process of transferring an RTP data block and related data exchange of the third embodiment of the present invention.

FIG. 19 is a flow chart of a process of the third embodiment of the present invention.

FIG. 20 illustrates a breakdown of data being used for decryption and data transfer management of a fourth embodiment of the present invention.

FIG. 21 illustrates a process of transferring an RTP data block and related data exchange of the fourth embodiment of the present invention.

FIG. 22 is a flow chart of a process of the fourth embodiment of the present invention.

FIG. 23 illustrates a series of transition of an RTP data block of the fourth embodiment of the present invention.

### DETAILED DESCRIPTION OF THE INVENTION

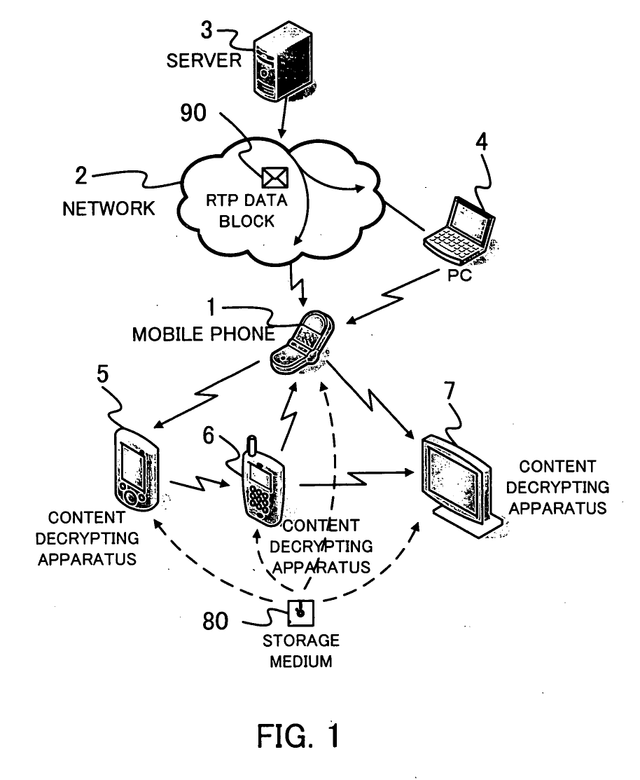

A first embodiment of the present invention will be described with reference to FIGS. 1-8. FIG. 1 is a conceptual diagram of a system including a mobile phone 1, a content decrypting apparatus of the first embodiment of the present invention. The mobile phone 1 may send and receive a plurality of radio signals to and from a base station (not shown) of a network 2.

The mobile phone 1 may read a piece of encrypted content from a storage medium 80. The mobile phone 1 may request a server 3 via the network 2 to send a block of data representing a right to decrypt and play the encrypted content and given a reference numeral 90 (hereinafter called the RTP data block 90, where RTP stands for “right to play”) stored in the server 3. The mobile phone 1 may receive the RTP data block 90 sent from the server 3.

The mobile phone 1 may decrypt and play the encrypted content using the RTP data block 90 and other necessary data. The RTP data block 90 may be received by a personal computer 4 via the network 2, and then transferred to the mobile phone 1 via, e.g. a local area network (LAN).

In FIG. 1, there are shown a content decrypting apparatus 5, a content decrypting apparatus 6 and a content decrypting apparatus 7. The content decrypting apparatus 5, 6 and 7 each may receive the RTP data block 90 transferred from the mobile phone 1 and may send the RTP data block 90 back to the mobile phone 1. The content decrypting apparatus 5, 6 and 7 may send and receive the RTP data block 90 (more exactly, as later described, a copy of the RTP data block 90) among each other. The content decrypting apparatus 5, 6 and 7 each may decrypt and play the encrypted content using the RTP data block 90 and other necessary data.

The mobile phone 1 and the content decrypting apparatus 5, 6 and 7 may send and receive (a copy of) the RTP data block 90 among each other via, e.g. a LAN, a removable memory, a short-range wireless link like Bluetooth (TM), an infrared link, and so on. If the content decrypting apparatus 5, 6 and 7 are connected to the network 2, the mobile phone 1 and the content decrypting apparatus 5, 6 and 7 may send and receive the RTP data block 90 among each other via the network 2.

The mobile phone 1 and the content decrypting apparatus 5, 6 and 7 each are given an individual device identifier (hereinafter called the device ID). The storage medium 80 is given an individual medium identifier (hereinafter called the medium ID). The RTP data block 90 is configured not to be used for decrypting the encrypted content in combination with at least one of a wrong device ID and a wrong medium ID, like the MKB earlier described with reference to Doi and Sasaki.

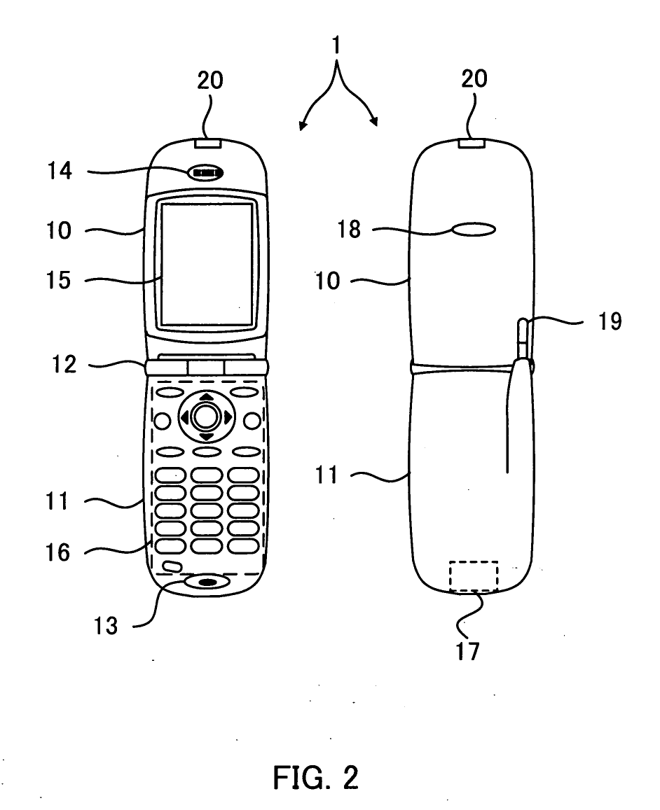

FIG. 2 is an external view of the mobile phone 1. The mobile phone 1 has a first case 10 and a second case 11 movably connected to each other by a connection 12. In a left area of FIG. 2, there is shown a front view of the mobile phone 1 while the first case 10 and the second case 11 are opened to each other. In a right area of FIG. 2, there is shown a rear view of the mobile phone 1 while the first case 10 and the second case 11 are opened to each other.

The mobile phone 1 has a microphone 13 on a front face of the second case 11. The mobile phone 1 has an earpiece 14 and a display 15 on a front face of the first case 10. The mobile phone 1 has a set of user controls 16 (hereinafter called the user control 16) on the front face of the second case 11 shown as surrounded by a dashed line. The user control 16 includes a plurality of numeric keys each of which may be used for entering a numeral, an alphabet and a symbol in a toggling manner. The user control 16 includes a navigation key which may be used for moving a cursor up, down, left and right on a screen of the display 15. The user control 16 includes a plurality of function keys each of which may be assigned a particular function.

The mobile phone 1 has a media reader 17 in an end portion of the second case 11. The mobile phone 1 has a speaker 18 on a rear face of the first case 10. The mobile phone 1 has an antenna 19 that may be extended from a rear face of the second case 11 toward the first case 10. The mobile phone 1 has a short-range wireless circuit 20 (hereinafter called the wireless circuit 20), e.g. based on Bluetooth (TM), in an end portion of the first case 10.

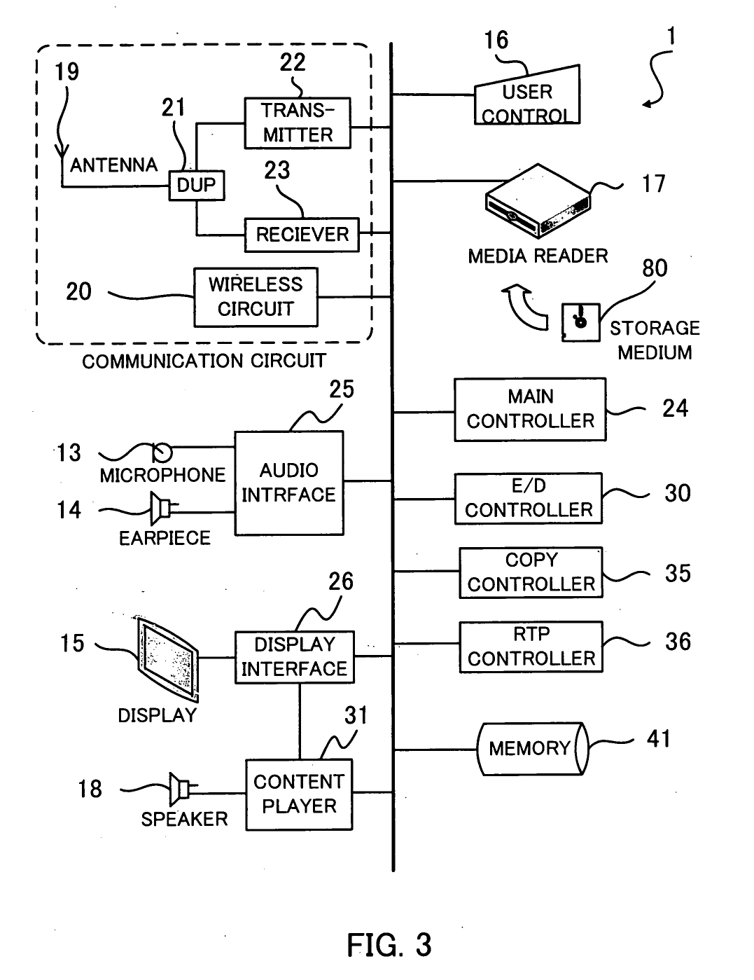

FIG. 3 is a block diagram of the mobile phone 1. The antenna 19 explained with reference to FIG. 1 is connected via a duplexer 21 to a transmitter 22 and a receiver 23. The transmitter 22 may encode a piece of uplink information, and may modulate, upconvert and amplify a frequency carrying the encoded information to produce an uplink radio signal. The transmitter 22 may provide the antenna 19 via the duplexer 21 with the uplink radio signal to emit to the base station of the network 2.

The receiver 23 may receive a downlink radio signal emitted from the base station via the antenna 19 and the duplexer 21. The receiver 24 may amplify, down-convert and demodulate the downlink radio signal, and may decode a demodulated output to extract a piece of downlink information.

The wireless circuit 20 includes an own antenna, a transmitter and a receiver, and may send and receive a plurality of short-range wireless signals, e.g. based on Bluetooth (TM). The antenna 19, the duplexer 21, the transmitter 22, the receiver 23 and the wireless circuit 20 form a communication circuit of the mobile phone 1.

The mobile phone 1 has a main controller 24 formed by a processing device like a microprocessor, a digital signal processor, etc. The main controller 24 may monitor and control each portion and a whole of the mobile phone 1. The main controller 24 is connected to an input port of the transmitter 22 and may send a plurality of uplink digital data to the transmitter 22. The main controller 24 is connected to an output port of the receiver 23 and may obtain a plurality of downlink digital data carried by a plurality of radio signals received by the receiver 23.

The main controller 24 is connected to the wireless circuit 20. The main controller 24 may provide a plurality of outgoing digital data with the wireless circuit 20 to transmit a plurality of outgoing short-range wireless signals, and may obtain a plurality of incoming digital data carried by a plurality of incoming short-range wireless signals received by the wireless circuit 20.

The user control 16 and the media reader 17 shown in FIG. 2 each are connected to the main controller 24. The storage medium 80 shown in FIG. 1 may be put in the media reader 17 so that a plurality of data stored in the storage medium 80 may be read via the media reader 17.

The microphone 13 shown in FIG. 2 is connected to the main controller 24 via an audio interface 25. The audio interface 25 may analog-to-digital convert and encode an analog voice signal picked up by the microphone 13 to produce a digital voice signal, and provide the transmitter 22 with the digital voice signal. The earpiece 14 shown in FIG. 2 is connected to the main controller 24 via the audio interface 25. The audio interface 25 may decode and digital-to-analog convert a digital voice signal received by the receiver 23 to produce an analog voice signal, and provide the earpiece 14 with the analog voice signal.

The display 15 shown in FIG. 2 is connected to the main controller 24 via a display interface 26. The main controller 24 may provide the display 15 via the display interface 26 with a plurality of images, a plurality of text data, etc. to be presented on the display 15.

The mobile phone 1 has an encrypt/decrypt controller 30 (hereinafter shortened as the E/D controller 30). The E/D controller 30 may decrypt a piece of encrypted content having been read via the media reader 17 from the storage medium 80, to reproduce a piece of plain content that contains a plurality of compressed images and sounds each in a digital form.

The display interface 26 and the speaker 18 shown in FIG. 2 each are connected to a content player 31, which is connected to the main controller 24 and the E/D controller 30. The content player 31 may expand a compressed image contained in the plain content reproduced by the E/D controller 30, and may provide the display 15 via the display interface 26 with the expanded image to present on the display 15. The content player 31 may expand a compressed sound contained in the plain content reproduced by the E/D controller 30 to produce an analog sound, and may provide the speaker 18 with the analog sound.

The mobile phone 1 has a copy controller 35 and an RTP data block controller 36 (hereinafter called the RTP controller 36), which will be explained later in detail. Regarding the main controller 24, the E/D controller 30, the copy controller 35 and the RTP controller 36, each and any combination of them may be formed by one processing device, and each may be formed by a separate processing device.

The mobile phone 1 has a memory 41 that may store the device ID given to the mobile phone 1 and a bunch of secret keys, both being usable for decrypting encrypted content. The memory 41 may store the RTP data block 90 that the mobile phone 1 receives from the server 3 as shown in FIG. 1. The RTP data block 90 comes from the server 3 to the base station (not shown) via the network 2, and is carried by a radio wave to reach the antenna 19. The RTP data block 90 is then received by the main controller 24 via the duplexer 21 and the receiver 23, and is stored in the memory 41.

The copy controller 35 may make a copy of the RTP data block 90 and may rewrite a portion of the copy as necessary to transfer, e.g. to the content decrypting apparatus 5 shown in FIG. 1. The main controller 24 receives a request for a transfer of the RTP data block 90 from the content decrypting apparatus 5 via the wireless link. The copy controller 35 makes a copy of the RTP data block 90 stored in the memory 41, rewrites a portion of the copy as necessary, and transfers the copy to the content decrypting apparatus 5 via the wireless link.

The RTP controller 36 may rewrite a portion of the RTP data block 90 stored in the memory 41 in accordance with a use of the RTP data block 90, and in accordance with a transfer of the RTP data block 90.

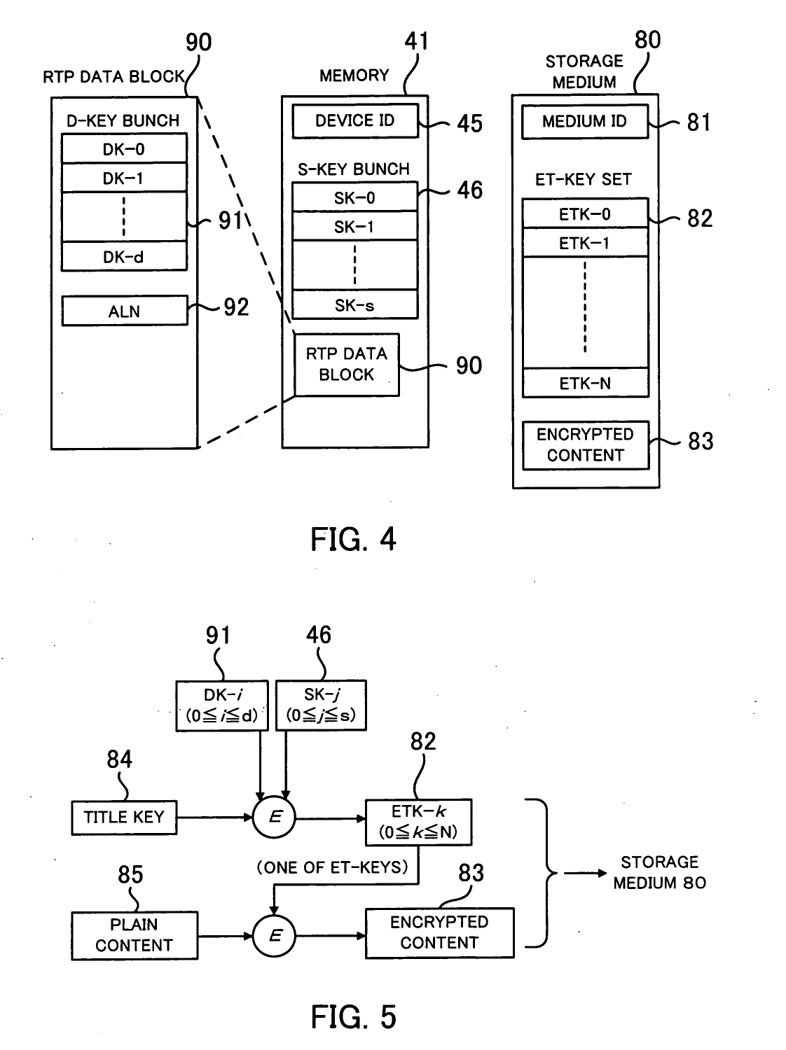

An operation of the mobile phone 1 of the first embodiment will be described with reference to FIGS. 4-8. FIG. 4 illustrates a breakdown of the RTP data block 90, a plurality of data stored in the memory 41 and a plurality of data stored in the storage medium 80. The RTP data block 90 includes a bunch of distributed keys 91 (hereinafter called the D-key bunch 91) formed by (d+1)-distributed keys where d is a positive integer. Each of the distributed keys of the D-key bunch 91 is denoted by DK-i where i is an integer between zero and d (0≦i≦d). The RTP data block 90 includes an allowed number of times (ALN) of decrypting and playing the encrypted content stored in the storage medium 80 given a reference numeral 92 and is hereinafter called the ALN 92. The ALN 92 is a positive integer.

The memory 41 stores the device ID given a reference numeral 45. The memory 41 stores a bunch of secret keys 46 (hereinafter called the S-key bunch 46) formed by (s+1) secret keys, where s is a positive integer. The memory 41 stores the RTP data block 90 described above. The device ID 45 is given to the mobile phone 1 as a specific value to identify one of the keys of the D-key bunch 91, DK-i (0≦i≦d) after being used as an input to a hash function producing (d+1) outputs (hereinafter called the first hash function).

One of the keys of the D-key bunch 91 identified by a wrong device ID may be made ineffective in advance for decrypting an encrypted title key, which will be explained later, so that a wrong content decrypting apparatus given the wrong device ID may be excluded. Each of the secret keys of the S-key bunch 46 is denoted by SK-j where j is an integer between zero and s (0≦j≦s).

The storage medium 80 stores the medium ID given a reference numeral 81. The storage medium 80 stores a set of encrypted title keys 82 (hereinafter called the ET-key set 82) formed by (N+1) encrypted title keys, where N is a positive integer equal to (d+1) times (s+1) minus one. The storage medium 80 stores the encrypted content given a reference numeral 83. The medium ID 81 is given to the storage medium 80 as a specific value to identify one of the keys of the S-key bunch 46, SK-j (0≦j≦d) after being used as an input to a hash function producing (s+1) outputs (hereinafter called second hash function).

The D-Key bunch 91 may be made ineffective in advance for decrypting any one of the encrypted title keys which corresponds to a wrong medium ID, so that a wrong storage medium given the wrong medium ID may be excluded. Each of the encrypted title keys of the ET-key set 82 is denoted by ETK-k where k is an integer between zero and N

(0≦k≦N=(d+1)X(s+1)−1).

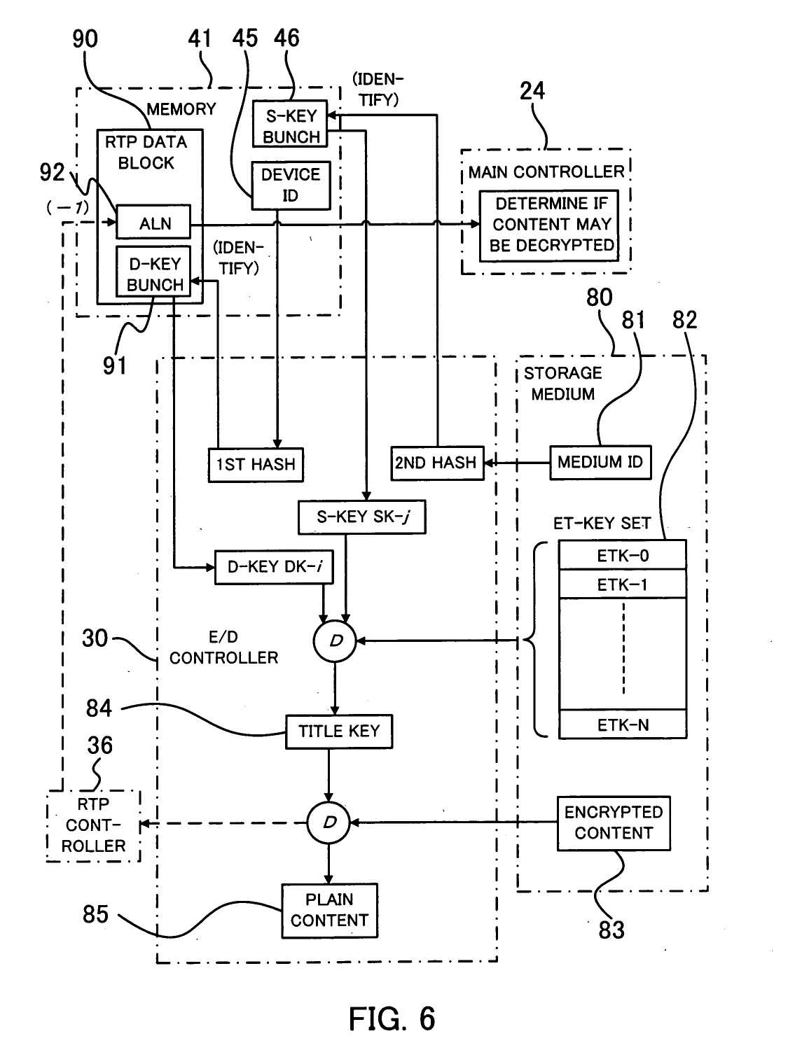

FIG. 5 illustrates a process of a recorder not shown in FIG. 1 by which the ET-key set 82 and the encrypted content 83 are produced and stored in the storage medium 80. The recorder holds a title key 84, a piece of plain content 85, a same D-key bunch 91 as the one included in the RTP data block 90, and a same S-key bunch 46 as the one stored in the memory 41.

The title key 84 is encrypted with every combination of each of the distributed keys DK-i (0≦i≦d) of the D-key bunch 91 and each of the secret keys SK-j (o≦j≦s) of the S-key bunch 46, and resultantly each of the encrypted title keys of the ET-key set 82 is produced. In FIG. 5, a process of encryption is denoted by an encircled “E”. It is desirable to use an algorithm of encryption and decryption that includes a process of checking if a decrypted result is correct, e.g. AES-WRAP (encryption) and AES-UNWRAP (decryption), in the first and following embodiments of the present invention.

The plain content 85 is encrypted with one of the encrypted title keys of the ET-key set 82, and resultantly the encrypted content 83 is produced. The ET-key set 82 and the encrypted content 83 are stored in the storage medium 80.

FIG. 6 illustrates a process of decrypting the encrypted content 83 read from the storage medium 80 and a process of exchanging related data among each portion of the mobile phone 1. FIG. 6 shows the main controller 24, the E/D controller 30, the RTP controller 36 and the memory 41, which are shown in FIG. 3, each by a dot-and-dash rectangle. FIG. 6 shows the storage medium 80 by another dot-and-dash rectangle, and omits to show the media reader 17.

After an instruction to decrypt the encrypted content 83 is entered on the user control 16, the main controller 24 reads the ALN 92 out of the RTP data block 90 stored in the memory 41. In a case where the ALN 92 has a value no less than one, the main controller 24 determines that the encrypted content 83 may be decrypted and played, and moves to a following step of the process. In a case where the ALN 92 has a value less than one, the main controller 24 determines that the encrypted content 83 may not be decrypted and played, and does not move to a following step of the process. In the latter case, the main controller 24 may present a message saying that the encrypted content 83 may not be decrypted.

In the above case where the encrypted content 83 may be decrypted, the E/D controller 30 reads the device ID 45 from the memory 41 and performs the first hash function on the device ID 45. The E/D controller 30 identifies one of the distributed keys DK-i (o≦i≦d) of the D-key bunch 90 based on an output of the first hash function. The E/D controller 30 reads the medium ID 81 from the storage medium 80 (via the media reader 17) and performs the second hash function on the medium ID 81. The E/D controller 30 identifies one of the distributed keys SK-j (o≦j≦s) of the S-key bunch 46 based on an output of the second hash function.

The E/D controller 30 reads each of the encrypted title keys ETK-k (0≦k≦N) of the ET-key set 82 from the storage medium 80, starting with k=0. The E/D controller 30 tries decrypting each encrypted title key ETK-k (0≦k≦N) with the identified distributed key DK-i and the identified secret key SK-j. In FIG. 6, a process of decryption is denoted by an encircled “D”. The decryption is based on, e.g. the AES-UNWRAP algorithm, and the E/D controller 30 may check if a decrypted result is correct.

As each of the encrypted title keys of the ET-key set 82 has been produced by encrypting the title key 84 with every combination of the distributed key DK-i (0≦i≦d) and the secret key SK-j (0≦j≦s), one of the encrypted title keys ETK-k (0≦k≦N) must be decrypted so that the title key 84 is reproduced.

The E/D controller 30 reads the encrypted content 83 from the storage medium 80, decrypts the encrypted content 83 with the title key 84 so as to reproduce the plain content 85. The E/D controller 30 checks if the result of decryption is correct, and in a case of a success of the decryption, informs the RTP controller 36 of the success of the decryption. The RTP controller 36 reduces the value of the ALN 92 stored in the memory 41 by one.

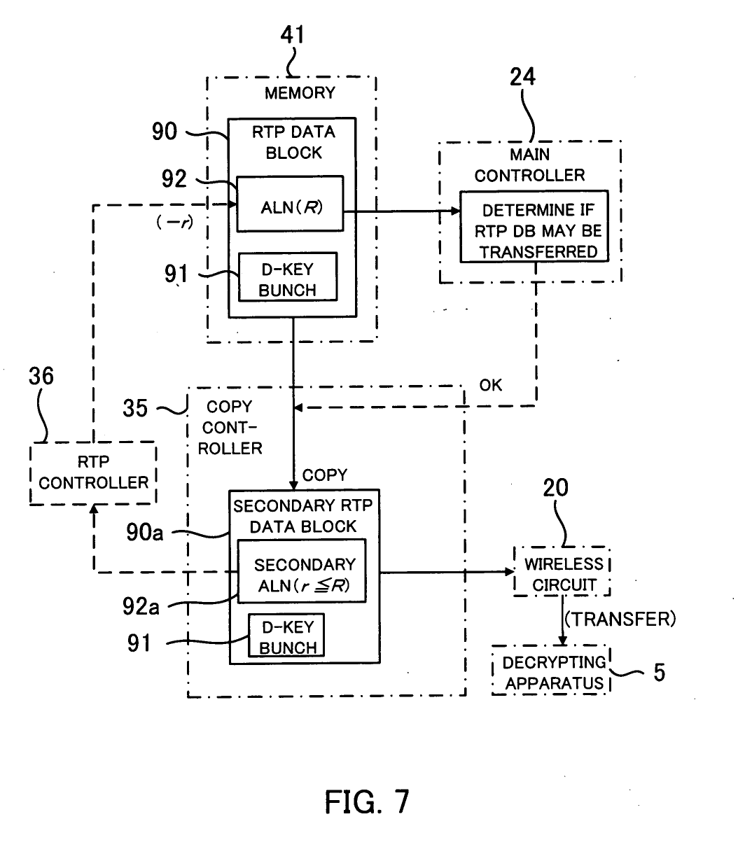

FIG. 7 illustrates a process of transferring (a copy of) the RTP data block 90 to another content decrypting apparatus (e.g. the content decrypting apparatus 5 shown in FIG. 1) and a process of exchanging related data among each portion of the mobile phone 1. FIG. 7 shows the wireless circuit 20, the main controller 24, the copy controller 35, the RTP controller 36 and the memory 41, each by a dot-and-dash rectangle. FIG. 7 shows the content decrypting apparatus 5 by another dot-and-dash rectangle.

Upon receiving a request for a transfer of an RTP data block from the content decrypting apparatus 5 via the wireless link, the main controller 24 reads the ALN 92 out of the RTP data block 90 stored in the memory 41. In a case where the ALN 92 has a value no less than one, the main controller 24 determines that the RTP data block 90 may be transferred, and moves to a following step of the process. In a case where the ALN 92 has a value less than one, the main controller 24 determines that the RTP data block 90 may not be transferred, and does not move to the following step of the process. In the latter case, the main controller 24 may present a message saying that the transfer may not be done, and may send a reply to the content decrypting apparatus 5 saying that the transfer may not be done.

In the above case where the RTP data block 90 may be transferred, the copy controller 35 copies the RTP data block 90 read from the memory 41 to produce a secondary RTP data block 90a, which includes a same D-key bunch 91 as the one included in the RTP data block 90 before being copied. If the ALN 92 of the RTP data block 90 is being a positive integer R, the copy controller may give a secondary ALN 92a of the secondary RTP data block 90a a positive integer r which is no greater than R (1≦r≦R). That is, at least a portion of the ALN 92 moves from the RTP data block 90 to the secondary RTP data block 90a. The integer r may be given by default. The integer r may be entered on the user control 16.

After the copy controller 35 informs the RTP controller 36 that the RTP data block 90 has been copied as described above, the RTP controller 36 reduces the value of the ALN 92 stored in the memory 41 by r. Consequently, there remains a right to decrypt and play the encrypted content 83 for (R-r) times in the mobile phone 1.

The copy controller 35 transfers the secondary RTP data block 90a to the content decrypting apparatus 5 via the wireless circuit 20. The content decrypting apparatus 5 may decrypt and play the encrypted content 83 for r times. The content decrypting apparatus 5 may copy the secondary RTP data block 90a to transfer to another content decrypting apparatus with an ALN value no greater than r.

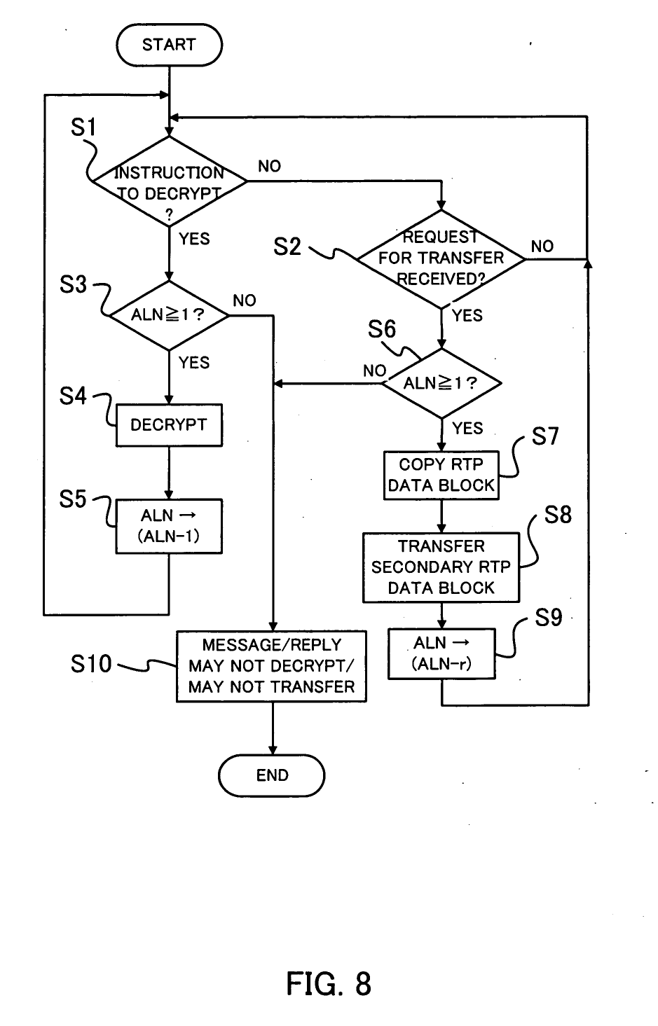

FIG. 8 is a flow chart illustrating a processing flow of the mobile phone 1 of the first embodiment of the present invention based on what has been described above. The flow starts while the RTP data block 90 is stored in the memory 41 (START). The main controller 24 waits for an instruction to decrypt the encrypted content 83 to be entered on the user control 16 (“NO” of step S1). Meanwhile, the main controller 24 waits for a request of a transfer of an RTP data block to be received from the content decrypting apparatus 5 via the wireless circuit 20 (“NO” of step S2).

After an instruction to decrypt the encrypted content 83 is entered (“YES” of step S1), the main controller 24 reads the ALN 92 from the memory 41. In a case where the ALN 92 has a value no less than one (“YES” of step S3), the E/D controller 30 decrypts the encrypted content 83 read from the storage medium 80 via the media reader 17 (step S4). Upon being informed of a success of the decryption from the E/D controller 30, the RTP controller 36 reduces the value of the ALN 92 stored in the memory 41 by one.

After a request of a transfer of an RTP data block is received at the step S2 (“YES” of step S2), the main controller 24 reads the ALN 92 from the memory 41. In a case where the ALN 92 has a value no less than one (“YES” of step S6), the copy controller 35 copies the RTP block data 90 to produce the secondary RTP block data 90a and gives the secondary ALN 92a a positive integer r (step S7). The copy controller 35 transfers the secondary RTP data block 90a to the content decrypting apparatus 5 (step S8). Upon being informed of the copy of the RTP data block 90 by the copy controller 35, the RTP controller 36 reduces the value of the ALN 92 stored in the memory 41 by r (step S9). The flow then goes back to the step S1 where another instruction to decrypt is waited for.

In a case where the value of the ALN 92 is less than one at the step S3 (“NO” of step S3), the main controller 24 presents a message on the display 15 saying that the encrypted content 83 may not be decrypted (step S10). In a case where the value of the ALN 92 is less than one at the step S6 (“NO” of step S6), the main controller 24 may present a message on the display 15 and may send a reply to the content decrypting apparatus 5, both saying that the RTP data block 90 may not be transferred (step S10), and then ends the flow (END).

The content decrypting apparatus 5, 6 and 7 each may run a same process using the secondary RTP data block 90a as the process of the mobile phone 1 described above. In a case where the mobile phone 1 and the content decrypting apparatus 5, 6 and 7 exchange the secondary RTP data block 90a via a LAN, a removable memory device, the network 2, etc., the mobile phone 1 does not need the wireless circuit 20.

According to the first embodiment described above, a content decrypting apparatus holding an RTP data block of a piece of encrypted content not only may decrypt the encrypted content stored in a storage medium but may transfer a secondary RTP data block to another content decrypting apparatus. A degree of freedom of utilizing the content may thereby be improved.

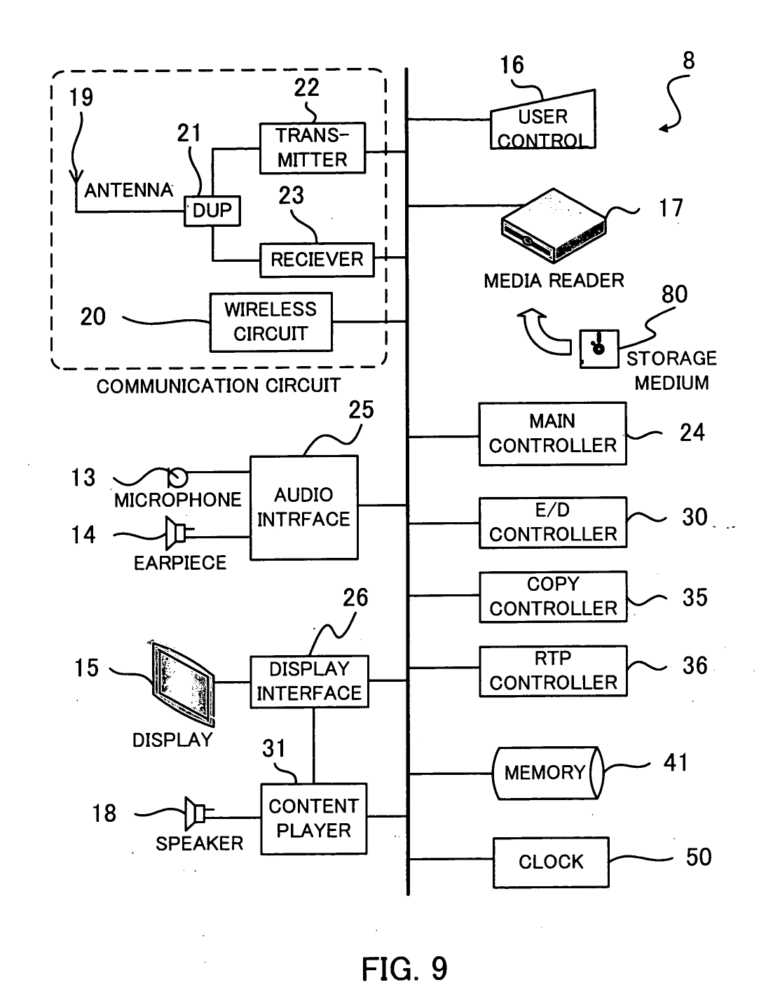

A second embodiment of the present invention will be described with reference to FIGS. 9-14. FIG. 1 may be referred to as necessary after being modified so that the mobile phone 1 is replaced by a mobile phone 8, a content decrypting apparatus of the second embodiment of the present invention, and the RTP data block 90 is replaced by an RTP data block 93 which will be explained later. FIG. 2 may be referred to as necessary, as the mobile phone 8 has a same external view as the one of the mobile phone 1.

FIG. 9 is a block diagram of the mobile phone 8, having a clock 50 indicating a present date and time. Each portion of the mobile phone 8 other than the clock 50 is a same as the corresponding one given a same reference numeral shown in FIG. 3, and its explanation is omitted.

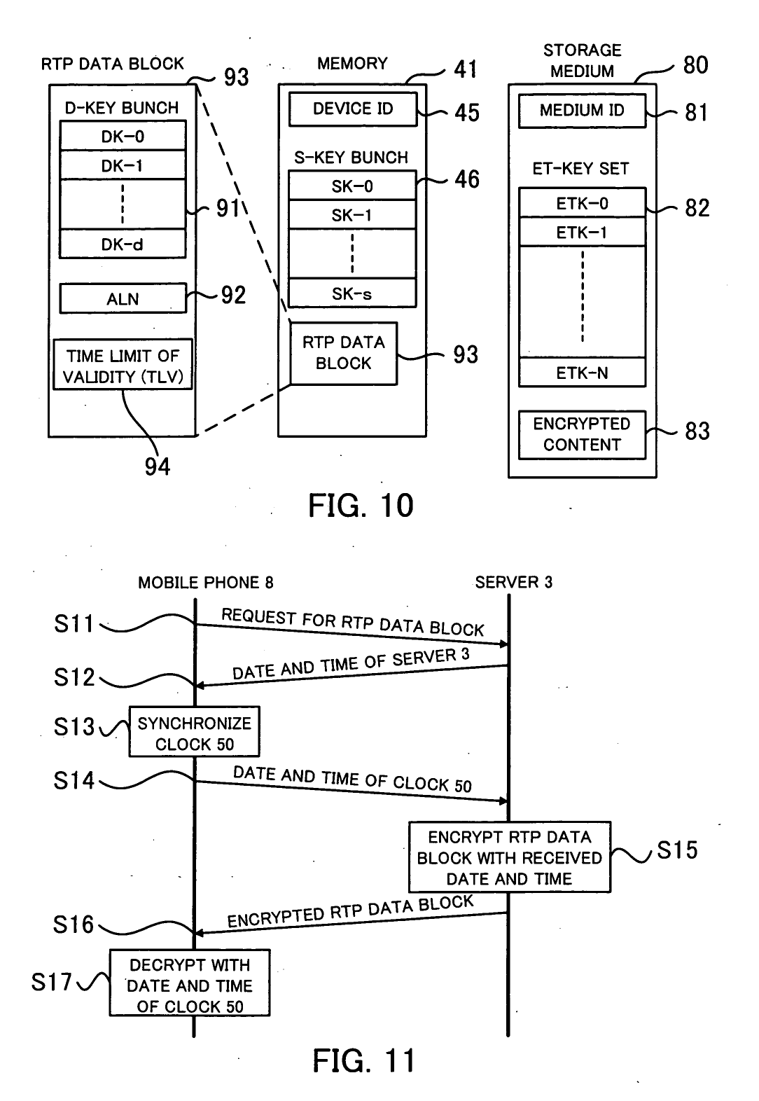

FIG. 10 illustrates a breakdown of the RTP data block 93, a plurality of data stored in the memory 41 and a plurality of data stored in the storage medium 80, like FIG. 4 of the first embodiment. The RTP data block 93 includes a time limit of validity 94 (hereinafter shortened as the TLV 94) in addition to the D-key bunch 91 and the ALN 92, each shown in FIG. 4. Each set of the data stored in the memory 41 and the storage medium 80 is a same as the corresponding one shown in FIG. 4 given the same reference numeral, and its explanation is omitted.

FIG. 11 illustrates a process of synchronizing the date and time indicated by the clock 50 of the mobile phone 8 with a date and time of the server 3 shown in FIG. 1. The mobile phone 1 sends a request for the RTP data block 93 to the server 3 via the network 2 (step S11). Upon receiving the request, the server 3 sends a date and time indicated by an internal clock (not shown in FIG. 1) to the mobile phone 8 via the network 2 (step S12).

The main controller 24 of the mobile phone 8 receives the date and time sent from the server 3 via the antenna 19, the duplexer 21 and the receiver 23. The main controller 24 synchronizes the date and time indicated by the clock 50 with the received date and time (step S13). The main controller 24 sends to the server 3 the date and time indicated by the clock 50, which has been synchronized with the received date and time, via the transmitter 22, the duplexer 21 and the antenna 19 and through the network 2 (step S14).

The server 3 encrypts the RTP data block 93 with the date and time received from the mobile phone 8 (step S15) using, e.g. the AES-WRAP algorithm. The server 3 sends the encrypted RTP data block 93 to the mobile phone 8 tracing a same path as that of the step S12 (step S16). The main controller 24 of the mobile phone 8 receives the encrypted RTP data block 93 sent from the server 3 via the antenna 19, the duplexer 21 and the receiver 23, and provides the E/D controller 30 with the encrypted RTP data block 93. The E/D controller 30 decrypts the encrypted RTP data block 93 with the date and time indicated by the clock 50 using, e.g. the AES-UNWRAP algorithm. The E/D controller 30 checks if a decrypted result is correct, and stores the decrypted RTP data block 93 in the memory 41 (step S17).

The above process of sending and receiving the RTP data block 93 encrypted with the date and time synchronized between the mobile phone 1 and the server 3 may exclude a wrong content decrypting apparatus being unsynchronized. If the date and time indicated by the clock 50 is kept from being altered, the mobile phone 8 may decrypt the encrypted content 83 only before the present date and time passes of the TLV 94 that has been set up on the server 3. The mobile phone 8 and another content decrypting apparatus, e.g. the content decrypting apparatus 5, may similarly send and receive the RTP data block 90 encrypted with a synchronized date and time between each other.

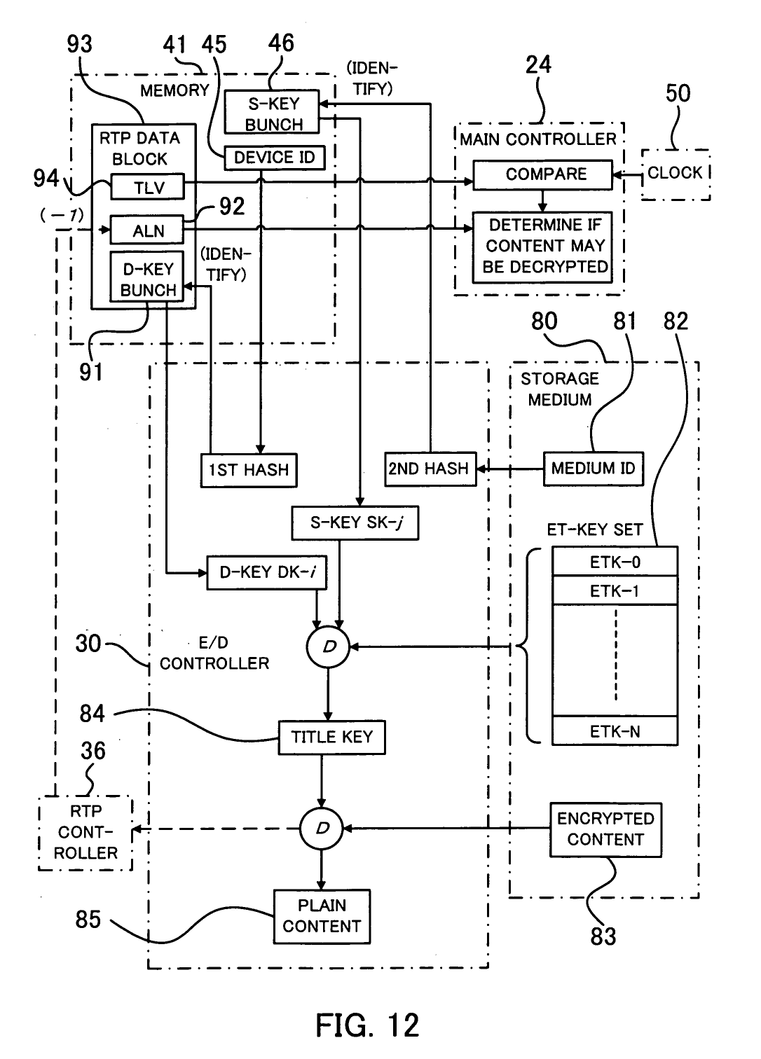

FIG. 12 illustrates a process of decrypting the encrypted content 83 read from the storage medium 80 and a process of exchanging related data among each portion of the mobile phone 8 of the second embodiment. In FIG. 12, the clock 50 is shown as a portion of the mobile phone 8, and the RTP data block 93 includes the TLV 94. Each portion of the mobile phone 8 other than the clock 50 and each set of data other than the TLV 94 are a same as the corresponding one shown in FIG. 6 given the same reference numeral.

After an instruction to decrypt the encrypted content 83 is entered on the user control 16, the main controller 24 reads the ALN 92 and the TLV 94 out of the RTP data block 93 stored in the memory 41. The main controller 24 reads a date and time indicated by the clock 50 to compare with the date and time of the TLV 94. In a case where the ALN 92 has a value no less than one while the date and time indicated by the clock 50 is before the date and time of the TLV 94, the main controller 24 determines that the encrypted content 83 may be decrypted and played, and moves to a following step of the process. A rest of what is illustrated in FIG. 12 is a same as what is illustrated in FIG. 6, and its explanation is omitted.

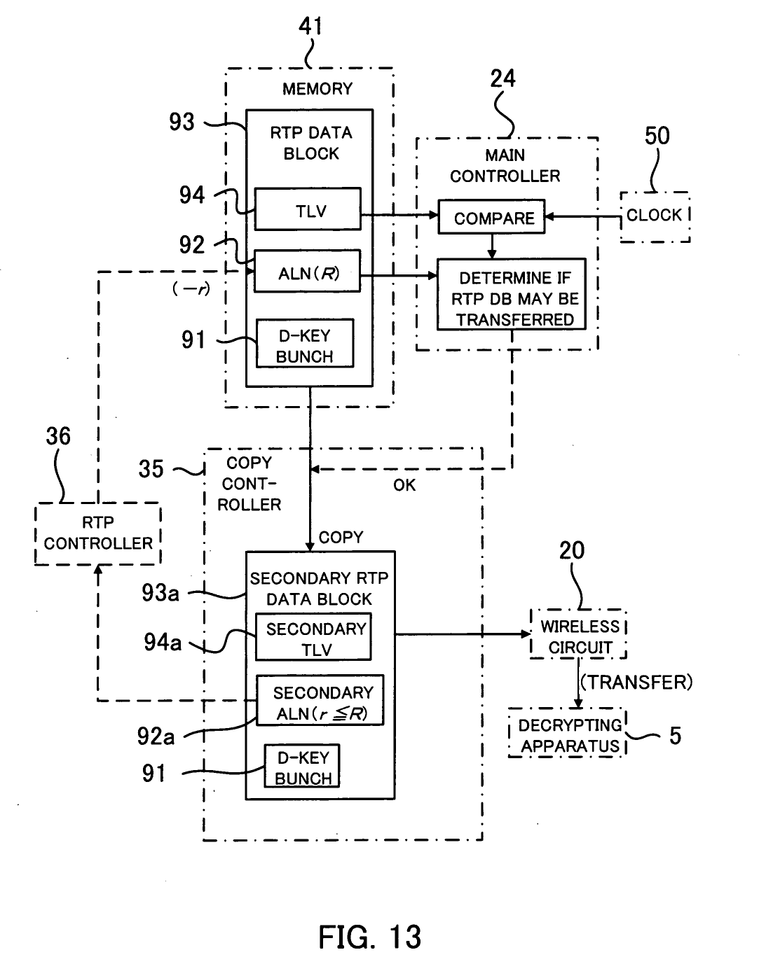

FIG. 13 illustrates a process of transferring (a copy of) the RTP data block 93 to another content decrypting apparatus (e.g. the content decrypting apparatus 5 shown in FIG. 1) and a process of exchanging related data among each portion of the mobile phone 8 of the second embodiment. In FIG. 13, the clock 50 is shown as a portion of the mobile phone 8, and the RTP data block 93 includes the TLV 94. Other than the clock 50 and the TLV 94, each portion of the mobile phone 8 and each set of data are a same as the corresponding one shown in FIG. 7 given the same reference numeral.

Upon receiving a request for a transfer of an RTP data block from the content decrypting apparatus 5 via the wireless link, the main controller 24 reads the ALN 92 and the TLV 94 out of the RTP data block 93 stored in the memory 41. The main controller 24 reads a date and time indicated by the clock 50 to compare with the date and time of the TLV 94. In a case where the ALN 92 has a value no less than one while the date and time indicated by the clock 50 is before the date and time of the TLV 94, the main controller 24 determines that the RTP data block 93 may be transferred, and moves to a following step of the process.

In the above case where the RTP data block 93 may be transferred, the copy controller 35 copies the RTP data block 93 read from the memory 41 to produce a secondary RTP data block 93a, which includes a same D-key bunch 91 as the one included in the RTP data block 93 before being copied. The copy controller 35 may replace a positive integer R of the ALN 92 by a positive integer r of the secondary ALN 92a, where r is no greater than R (1≦r≦R), in a same way as in the first embodiment.

The secondary RTP data block 93a includes a secondary TLV 94a. The copy controller 35 may replace the date and time of the TLV 94 by a different date and time of the secondary TLV 94a. The secondary TLV 94a may be set by default, e.g. extended for three days, extended by an end of a week, etc. The date and time of the secondary TLV 94a may be entered on the user control 16. A rest of what is illustrated in FIG. 13 is a same as what is illustrated in FIG. 7, and its explanation is omitted.

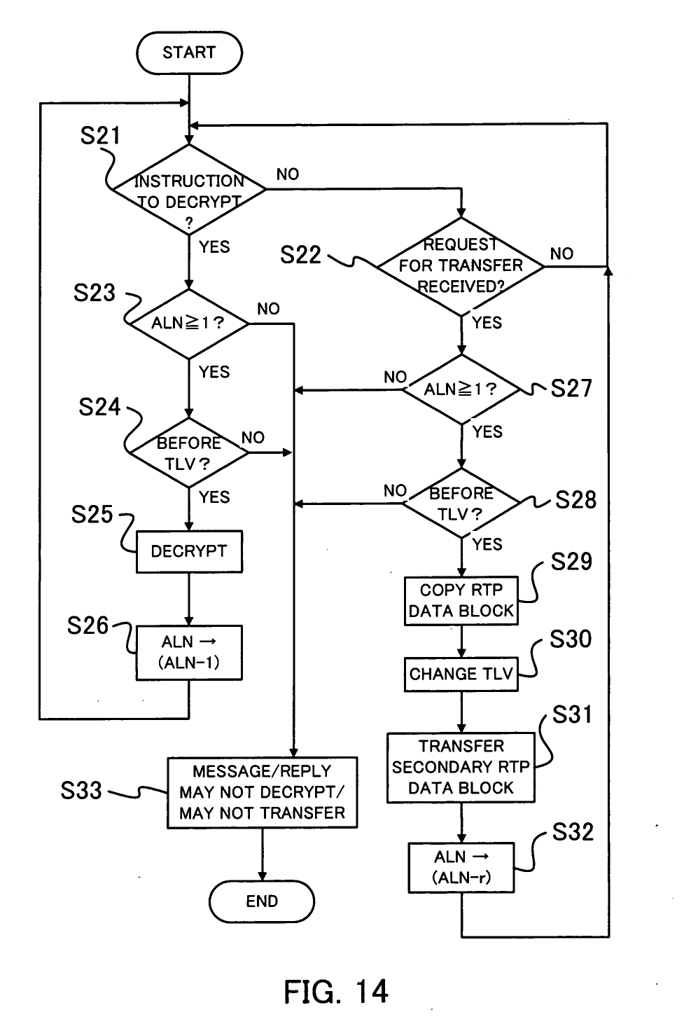

FIG. 14 is a flow chart illustrating a processing flow of the mobile phone 8 of the second embodiment of the present invention based on what has been described above. After the flow starts (START), each of steps S21-S23 is a same as the steps S1-S3 shown in FIG. 8, respectively, and its explanation is omitted. Following “YES” of the step S23, the main controller 24 compares the date and time indicated by the clock 50 with the date and time of the TLV 94. While the date and time indicated by the clock 50 is before the date and time of the TLV 94 (“YES” of step S24), the flow moves to a next step. Each of steps S25-S26 is a same as the steps S4-S5 shown in FIG. 8, respectively, and its explanation is omitted.

A step S27 that follows “YES” of the step S22 is a same as the step 6 shown in FIG. 8, and its explanation is omitted. The main controller 24 compares the date and time indicated by the clock 50 with the date and time of the TLV 94. While the date and time indicated by the clock 50 is before the date and time of the TLV 94 (“YES” of step S28), the flow moves to a next step. A step S29 that follows is a same as the step 7 shown in FIG. 8, and its explanation is omitted. The copy controller 35 gives a date and time of the secondary TLV 94a of the secondary RTP data block (step S30). Each of steps S31-S32 is a same as the steps S8-S9 shown in FIG. 8, respectively, and its explanation is omitted.

In a case where the value of the ALN 92 is less than one at the step S23 (“NO” of step S23), the main controller 24 presents a message on the display 15 saying that the encrypted content 83 may not be decrypted (step S33). In a case where the value of the ALN 92 is less than one at the step S27 (“NO” of step S27), the main controller 24 may present a message on the display 15 and may send a reply to the content decrypting apparatus 5, both saying that the RTP data block 93 may not be transferred (step S33), and then ends the flow (END).

After the date and time indicated by the clock 50 passes the date and time of the TLV 94 at the step S24 (“NO” of step S24), the main controller 24 presents a message on the display 15 saying that the encrypted content 83 may not be decrypted (step S33). After the date and time indicated by the clock 50 passes the date and time of the TLV 94 at the step S28 (“NO” of step S28), the main controller 24 may present a message on the display 15 and may send a reply to the content decrypting apparatus 5, both saying that the RTP data block 93 may not be transferred (step S33), and then ends the flow (END).

The content decrypting apparatus 5, 6 and 7 each may run a same process using the secondary RTP data block 93a as the process of the mobile phone 8 of the second embodiment described above. In a case where the mobile phone 8 and the content decrypting apparatus 5, 6 and 7 exchange the secondary RTP data block 93a via a LAN, a removable memory device, the network 2, etc., the mobile phone 8 does not need the wireless circuit 20.

According to the second embodiment described above, a content decrypting apparatus may decrypt a piece of encrypted content and may transfer an RTP data block only while a clock-indicated date and time is before a time limit of validity (TLV), and may give another date and time of the TLV to a secondary RTP data block to be transferred to another content decrypting apparatus.

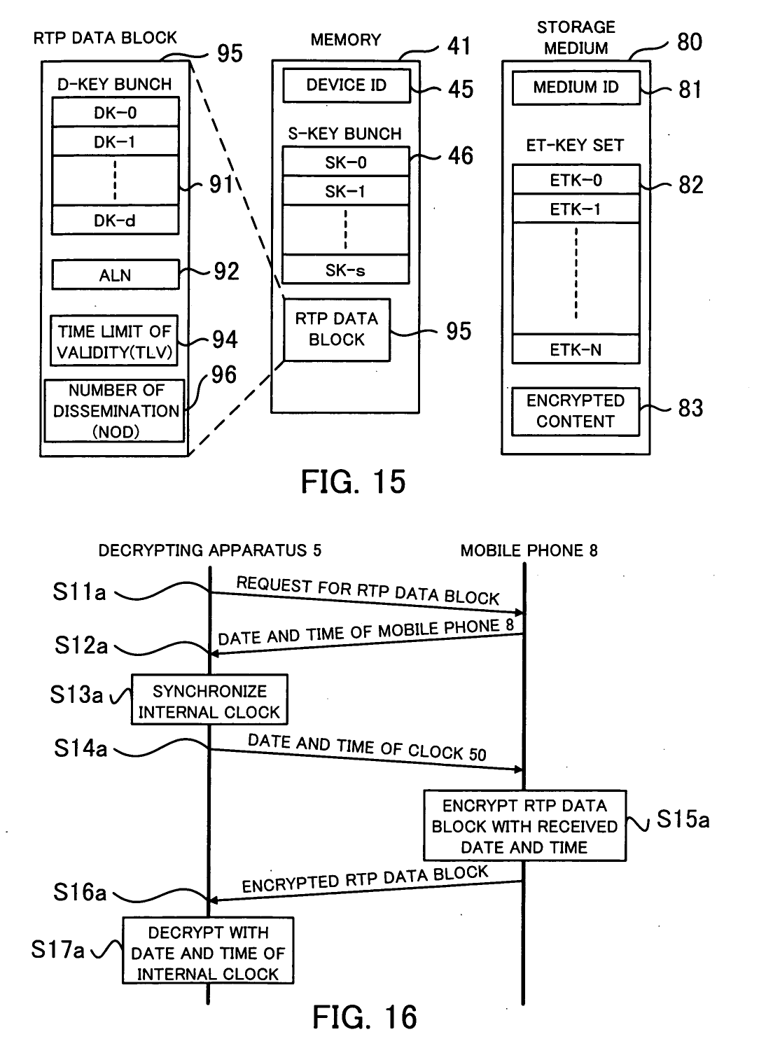

A third embodiment of the present invention will be described with reference to FIGS. 15-19. Assume that a content decrypting apparatus of the third embodiment of the present invention is a same as the mobile phone 8 of the second embodiment. FIG. 1 may be referred to as necessary after being modified so that the mobile phone 1 is replaced by the mobile phone 8, and the RTP data block 90 is replaced by an RTP data block 95 which will be explained later. The drawings referred to in the previous embodiments may be referred to in the third embodiment as necessary.

FIG. 15 illustrates a breakdown of the RTP data block 95, a plurality of data stored in the memory 41 and a plurality of data stored in the storage medium 80 like FIG. 10 of the second embodiment. The RTP data block 95 includes a number of dissemination 96 (hereinafter shortened as the NOD 96) in addition to the D-key bunch 91, the ALN 92 and the TLV 94, each shown in FIG. 10. Each set of the data stored in the memory 41 and the storage medium 80 is a same as the corresponding one shown in FIG. 10 given the same reference numeral, and its explanation is omitted. The NOD 96 represents a number of content decrypting apparatus to which one of the RTP data block 95 and a copy of the RTP data block 95 mentioned later is simultaneously disseminated.

FIG. 16 illustrates a process of synchronizing a date and time between the mobile phone 8 and another content decrypting apparatus, e.g. the content decrypting apparatus 5 shown in FIG. 1. The mobile phone 8 and the content decrypting apparatus 5 shown in FIG. 16 each correspond to the server 3 and the mobile phone 8 shown in FIG. 11, respectively. Each of steps S11a-S17a shown in FIG. 16 corresponds to each of the steps S11-S17 shown in FIG. 11, respectively. An “internal clock” of the content decrypting apparatus 5 shown in FIG. 16 corresponds to the clock 50 shown in FIG. 11. A rest of what is illustrated in FIG. 16 is a same as what is illustrated shown in FIG. 11, and its explanation is omitted.

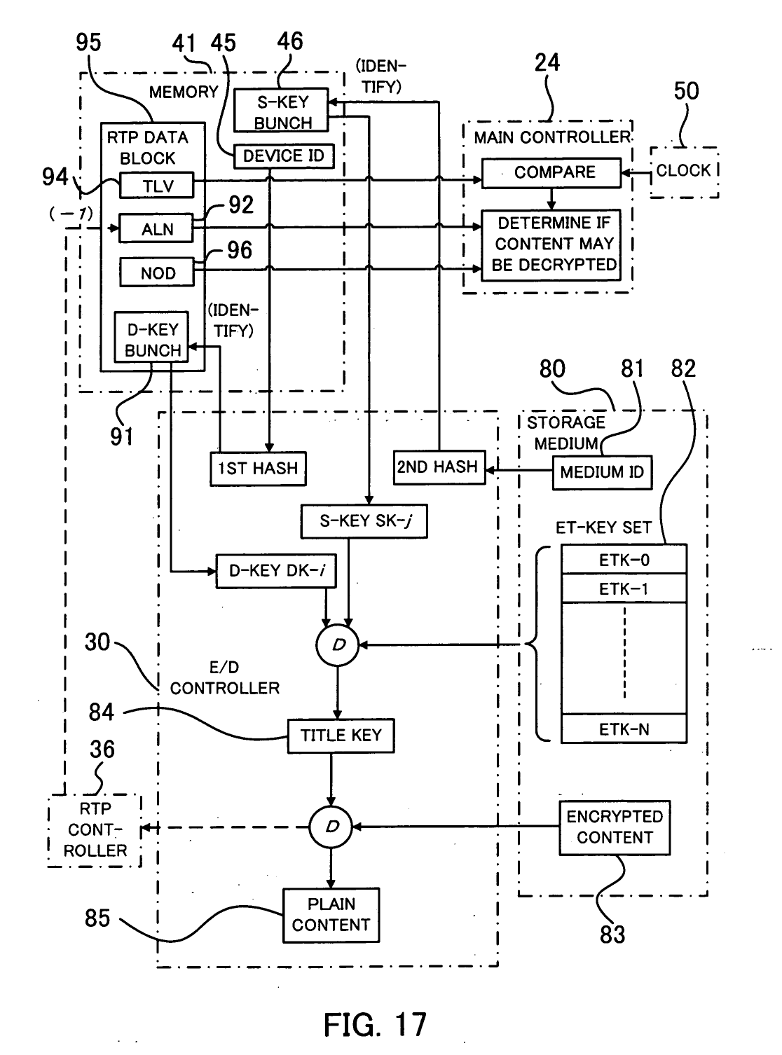

FIG. 17 illustrates a process of decrypting the encrypted content 83 read from the storage medium 80 and a process of exchanging related data among each portion of the mobile phone 8 of the third embodiment. In FIG. 17, the RTP data block 95 includes the NOD 96. Each portion of the mobile phone 8 and each set of data other than the NOD 96 are a same as the corresponding one shown in FIG. 12 given the same reference numeral.

After an instruction to decrypt the encrypted content 83 is entered on the user control 16, the main controller 24 reads the ALN 92, the TLV 94 and the NOD 96 out of the RTP data block 95 stored in the memory 41. The main controller 24 reads a date and time indicated by the clock 50 to compare with the date and time of the TLV 94. In a case where the ALN 92 and the NOD 96 each have a value no less than one while the date and time indicated by the clock 50 is before the date and time of the TLV 94, the main controller 24 determines that the encrypted content 83 may be decrypted and played, and moves to a following step of the process. A rest of what is illustrated in FIG. 17 is a same as what is illustrated shown in FIG. 12, and its explanation is omitted.

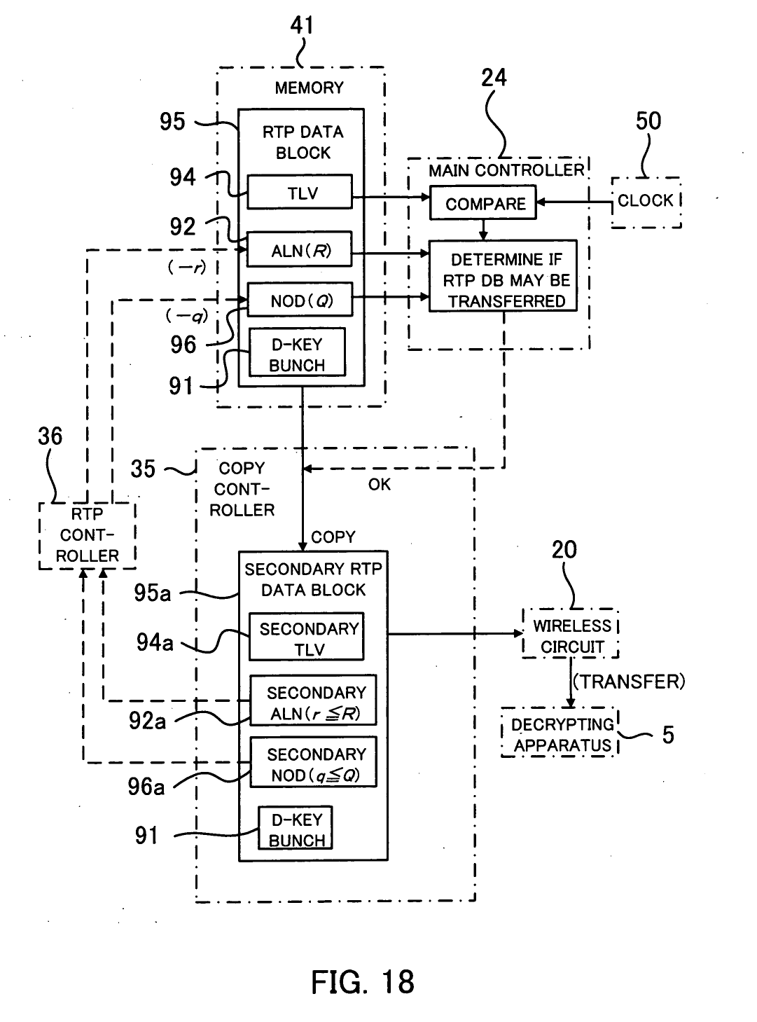

FIG. 18 illustrates a process of transferring (a copy of) the RTP data block 95 to another content decrypting apparatus (e.g. the content decrypting apparatus 5 shown in FIG. 1) and a process of exchanging related data among each portion of the mobile phone 8 of the third embodiment. In FIG. 18, the RTP data block 95 includes the NOD 96. Each portion of the mobile phone 8 and each set of data other than the NOD 96 are a same as the corresponding one shown in FIG. 13 given the same reference numeral.

Upon receiving a request for a transfer of an RTP data block from the content decrypting apparatus 5 via the wireless link, the main controller 24 reads the ALN 92, the TLV 94 and the NOD 96 out of the RTP data block 95 stored in the memory 41. The main controller 24 reads a date and time indicated by the clock 50 to compare with the date and time of the TLV 94. In a case where the ALN 92 and the NOD 96 each have a value no less than one while the date and time indicated by the clock 50 is before the date and time of the TLV 94, the main controller 24 determines that the RTP data block 95 may be transferred, and moves to a following step of the process.

In the above case where the RTP data block 95 may be transferred, the copy controller 35 copies the RTP data block 95 read from the memory 41 to produce a secondary RTP data block 95a, which includes a same D-key bunch 91 as the one included in the RTP data block 95 before being copied. The copy controller 35 may replace a positive integer R of the ALN 92 by a positive integer r of the secondary ALN 92a, where r is no greater than R (1≦r≦R), in a same way as in the first and the second embodiments. The secondary RTP data block 95a includes a secondary TLV 94a. The copy controller 35 may replace the date and time of the TLV 94 by a different date and time of the secondary TLV 94a in a same way as in the second embodiment.

If the NOD 96 of the RTP data block 95 is being a positive integer Q, the copy controller may give a secondary NOD 96a of the secondary RTP data block 95a a positive integer q which is no greater than Q (1≦q≦Q). That is, at least a portion of the NOD 96 moves from the RTP data block 95 to the secondary RTP data block 95a. The integer q may be given by default. The integer q may be entered on the user control 16.

After the copy controller 35 informs the RTP controller 36 that the RTP data block 95 has been copied as described above, the RTP controller 36 reduces the value of the NOD 96 stored in the memory 41 by q. Consequently, there is left a right of a number of dissemination reduced by q in the mobile phone 8.

The copy controller 35 transfers the secondary RTP data block 95a to the content decrypting apparatus 5 via the wireless circuit 20. The content decrypting apparatus 5 may copy the secondary RTP data block 95a to transfer to another content decrypting apparatus with an NOD value no greater than q.

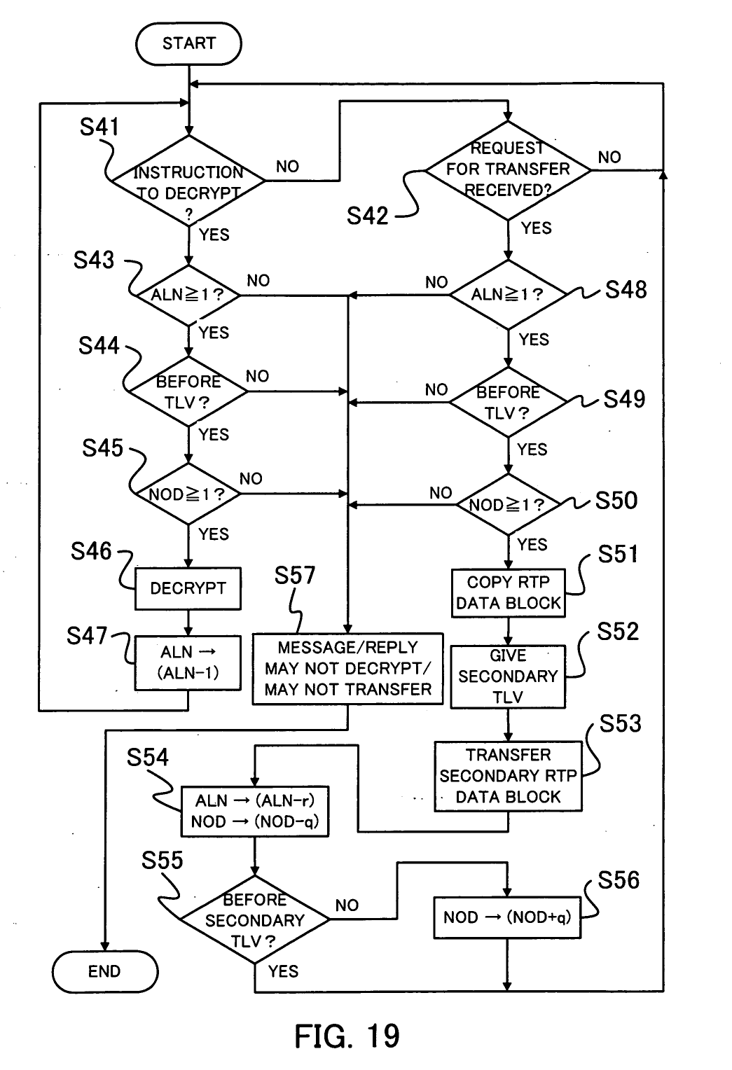

FIG. 19 is a flow chart illustrating a processing flow of the mobile phone 8 of the third embodiment of the present invention based on what has been described above. After the flow starts (START), each of steps S41-S44 is a same as the steps S21-S24 shown in FIG. 14, respectively, and its explanation is omitted. Following “YES” of the step S44, the main controller 24 reads the NOD 96 out of the RTP data block 95 from the memory 41. In a case where the NOD 96 is no less than one (“YES” of step S45), the flow moves to a next step. Each of steps S46-S47 is a same as the steps S25-S26 shown in FIG. 14, respectively, and its explanation is omitted.

Each of steps S48-S49 that follow “YES” of the step S42 is a same as the steps S27-S28 shown in FIG. 12, respectively, and its explanation is omitted. Following “YES” of the step S49, the main controller 24 reads the NOD 96 out of the RTP data block 95 from the memory 41. In a case where the NOD 96 is no less than one (“YES” of step S50), the flow moves to a next step. Each of steps S51-S53 is a same as the steps S29-S31 shown in FIG. 14, respectively, and its explanation is omitted.

After the copy controller 35 informs the RTP controller 36 that the RTP data block 95 has been copied as described above, the RTP controller 36 reduces the value of the ALN 92 stored in the memory 41 by r (an amount given to the secondary RTP data block 95a), and reduces the value of the NOD 96 stored in the memory 41 by q (an amount given to the secondary RTP data block 95a) (step S54).

The RTP controller 36 then watches the date and time indicated by the clock 50. After the date and time indicated by the clock 50 passes the date and time of the secondary TLV 94a (“NO” of step S55), the RTP controller 36 increases the value of the NOD 96 by q, the amount given to the secondary RTP data block 95a at the step S54 (step S56). After the date and time of the secondary TLV 94a, the content decrypting apparatus having received the secondary RTP data block 95a, e.g. the content decrypting apparatus 5, may neither use nor transfer the secondary RTP data block 95a any longer. The mobile phone 8 may then retrieve the value of the secondary NOD 96a.

While the date and time indicated by the clock 50 is before the date and time of the secondary TLV 94a (“YES” of step S55), the flow goes back to the step S41, and the main controller 24 waits for one of another instruction to decrypt and another request for a transfer of an RTP data block. After the step S56, the flow goes back to the step S41, too.

In a case where the value of the ALN 92 is less than one at the step S43 (“NO” of step S43) and in a case where the value of the NOD 96 is less than one at the step S45 (“NO” of step S45), the main controller 24 may present a message on the display 15 saying that the encrypted content 83 may not be decrypted (step S57), and then ends the flow (END). After the date and time indicated by the clock 50 passes the date and time of the TLV 94 at the step S44 (“NO” of step S43), the main controller 24 may present a message on the display 15 saying that the encrypted content 83 may not be decrypted (step S57), and then ends the flow (END).

In a case where the value of the ALN 92 is less than one at the step S48 (“NO” of step S48) and in a case where the value of the NOD 96 is less than one at the step S50 (“NO” of step S50), the main controller 24 may present a message on the display 15 and may send a reply to the content decrypting apparatus 5, both saying that the RTP data block 95 may not be transferred (step S57), and then ends the flow (END). After the date and time indicated by the clock 50 passes the date and time of the TLV 94 at the step S49 (“NO” of step S49), the main controller 24 may present a message on the display 15 and may send a reply to the content decrypting apparatus 5, both saying that the RTP data block 95 may not be transferred (step S57), and then ends the flow (END).

An RTP data block having no time limit of validity but having a number of dissemination may be considered. In such a case, the steps relating to the TLV 94 and the steps relating to the secondary TLV 94a may be deleted in FIGS. 17-19. The content decrypting apparatus 5, 6 and 7 each may run a same process using the secondary RTP data block 95a as the process of the mobile phone 8 of the third embodiment described above.

According to the third embodiment described above, a content decrypting apparatus may decrypt a piece of encrypted content and may transfer an RTP data block as limited by a number of dissemination (NOD), and may give a secondary RTP data block another value of the NOD to transfer to another content decrypting apparatus.

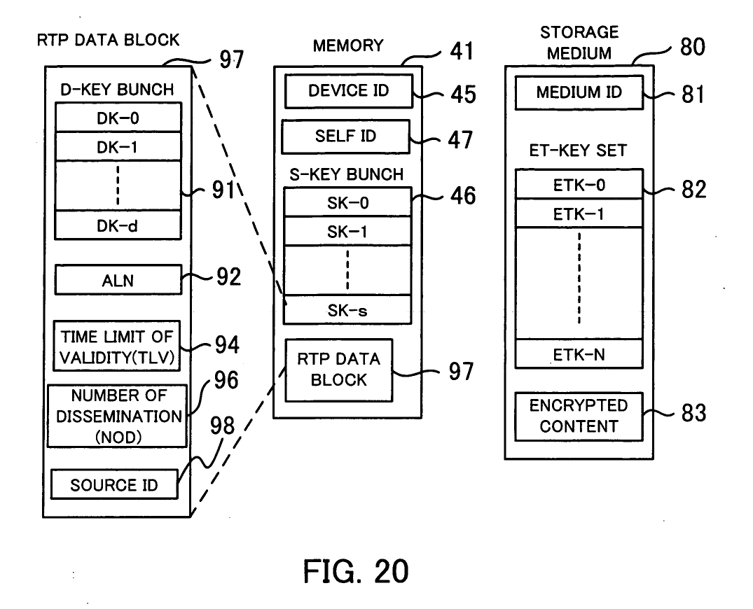

A fourth embodiment of the present invention will be described with reference to FIGS. 20-23. Assume that a content decrypting apparatus of the fourth embodiment of the present invention is a same as the mobile phone 8 of the second and the third embodiments. FIG. 1 may be referred to as necessary after being modified so that the mobile phone 1 is replaced by the mobile phone 8, and the RTP data block 90 is replaced by an RTP data block 97 which will be explained later. The drawings referred to in the previous embodiments may be referred to in the fourth embodiment as necessary.

FIG. 20 illustrates a breakdown of the RTP data block 97, a plurality of data stored in the memory 41 and a plurality of data stored in the storage medium 80. The RTP data block 97 includes an identifier of a disseminating source 98 (hereinafter called the source ID 98) in addition to the D-key bunch 91, the ALN 92, the TLV 94 and the NOD 96, each shown in FIG. 15. The memory 41 stores a self identifier 47 (hereinafter called the self ID 47) that equals a source ID of the mobile phone 1 in addition to the device ID 45 and the S-key bunch 46 each shown in FIG. 4. The device ID 45 may be served as the self ID 47.

Each set of the data stored in the memory 41 and the storage medium 80 is a same as the corresponding one shown in FIG. 15 given the same reference numeral, and its explanation is omitted. A process of synchronizing a date and time among the mobile phone 8, the server 3 and the other content decrypting apparatus is a same as the corresponding one described in the second and the third embodiments.

The source ID 98 is of one of a first kind and a second kind. A source ID of the first kind represents an apparatus disseminating an RTP data block. A source ID of the second kind represents an apparatus receiving and using the RTP data block to decrypt a piece of encrypted content corresponding to the RTP data block. The server 3 shown in FIG. 1 has a source ID of the first kind. The mobile phone 8 and the content decrypting apparatus 5, 6 and 7 each have a source ID of the second kind.

A process of decrypting the encrypted content 83 read from the storage medium 80 and a process of exchanging related data among each portion of the mobile phone 8 of the fourth embodiment may be illustrated by FIG. 17, except that the RTP data block 95 is replaced by the RTP data block 97, and its explanation is omitted.

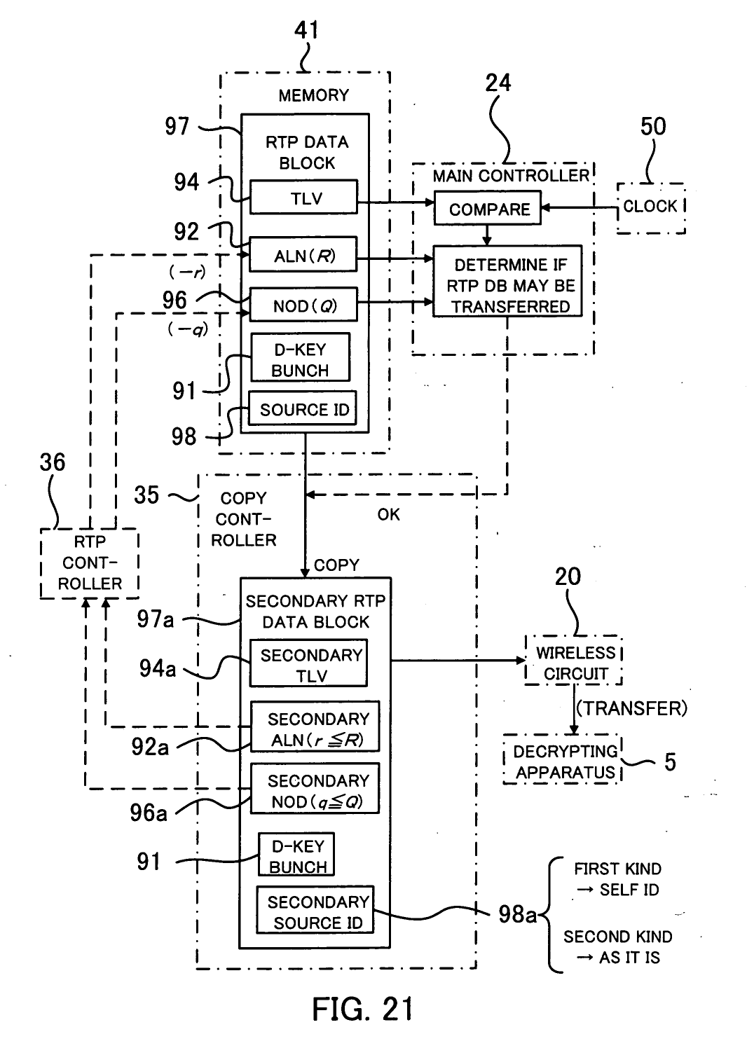

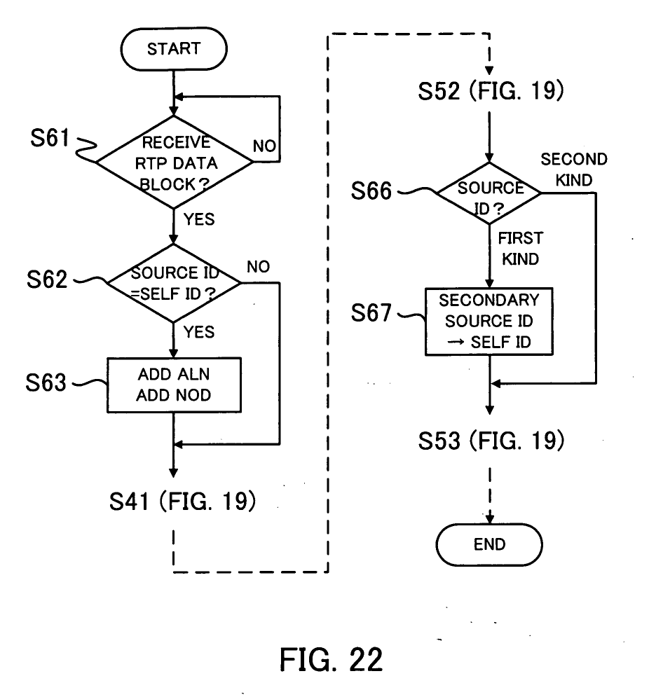

FIG. 21 illustrates a process of transferring (a copy of) the RTP data block 97 to another content decrypting apparatus (e.g. the content decrypting apparatus 5 shown in FIG. 1) and a process of exchanging related data among each portion of the mobile phone 8 of the fourth embodiment. In FIG. 21, the RTP data block 97 includes the source ID 98. Each portion of the mobile phone 8 and each set of data other than the source ID 98 are a same as the corresponding one shown in FIG. 18 given the same reference numeral.

In a case where the main controller 24 determines that the RTP data block 97 may be transferred in a same way as in the third embodiment, the copy controller 35 copies the RTP data block 97 read from the memory 41 to produce a secondary RTP data block 97a, which includes a same D-key bunch 91 as the one included in the RTP data block 97 before being copied. The copy controller 35 may replace a positive integer R of the ALN 92 by a positive integer r of the secondary ALN 92a in a same way as in the previous embodiments, where r is no greater than R (1≦r≦R).

The copy controller 35 may replace the date and time of the TLV 94 by a different date and time of the TLV 94a in a same way as in the second and the third embodiments. The copy controller 35 may replace a positive integer Q of the NOD 96 by a positive integer q of the secondary NOD 96a in a same way as in the third embodiment, where q is no greater than Q (1≦q≦Q).

In a case where the source ID 98 of the RTP data block 97 is of the first kind, the copy controller 35 replaces the source ID 98 by the self ID 47 to give a secondary source ID 98a. In a case where the source ID 98 of the RTP data block 97 is of the second kind, the copy controller 35 maintains the source ID 98 as it is to give the secondary source ID 98a.

As the source ID 98 of the RTP data block 97 that the mobile phone 8 has received from the server 3 is of the first kind, the source ID 98 is replaced by the self ID 47, a source ID of the second kind, for a transfer of the secondary RTP data block 97a to the content decrypting apparatus 5. In a case where the content decrypting apparatus 5 transfers a copy of the secondary RTP data block 97a to the content decrypting apparatus 6, 7 and so on, the self ID 47 is maintained as the source ID of the copied RTP data block.

One of the content decrypting apparatus may consequently send the secondary RTP data block 97a with the self ID 47 back to the mobile phone 8. It may be interpreted that the mobile phone 8 retrieves the secondary RTP data block 97a. The RTP controller 36 may add the value of the secondary ALN 92a to the value of the ALN 92 stored in the memory 41. The RTP controller 36 may add the value of the secondary NOD 96a to the value of the NOD 96 stored in the memory 41.

A processing flow relating to the source ID will be described with reference to FIG. 22, a flow chart of the mobile phone 8 of the fourth embodiment of the present invention based on what has been described above, and complementing FIG. 19 of the third embodiment. FIG. 22 only shows what is not shown in FIG. 19 of the third embodiment. The flow starts while the RTP data block 97 is stored in the memory 41 (START). The main controller 24 waits for another RTP data block to be received via the antenna 19, the duplexer 21 and the receiver 23 (“NO” of step S61). The main controller 24 may wait for another RTP data block to be received via the wireless circuit 20.

In a case where a source ID of a received RTP data block equals the self ID 47 (“YES” of step S62), it may be interpreted that the secondary RTP data block 97a has been sent back to the mobile phone 8. The RTP controller 36 adds the value of the secondary ALN 92a that has been sent back to the value of the ALN 92 stored in the memory 41. The RTP controller 36 adds the value of the secondary NOD 96a that has been sent back to the value of the NOD 96 stored in the memory 41 (step S63). The flow goes to the step S41 of FIG. 19.

Following the step 52 of FIG. 19 and in a case where the secondary source ID 98a of the secondary RTP data block 97a copied at the step 51 of FIG. 19 is of the first kind (“FIRST KIND” of step S66), the copy controller 35 replaces the secondary source ID 98a by the self ID 47 (step S67), and goes to the step S53 of FIG. 19. In a case where the secondary source ID 98a is of the second kind (“SECOND KIND” of step S66), the copy controller 35 maintains the secondary source ID 98a as it is, and goes to the step S53 of FIG. 19.

An RTP data block having no time limit of validity but having a source ID may be considered. In such a case, the steps relating to the TLV 94 and the steps relating to the secondary TLV 94a may be deleted in FIGS. 21-22. An RTP data block having no number of dissemination but having a source ID may be considered. In such a case, the steps relating to the NOD 96 and the steps relating to the secondary NOD 96a may be deleted in FIGS. 21-22. The content decrypting apparatus 5, 6 and 7 each may run a same process using the secondary RTP data block 97a as the process of the mobile phone 8 of the fourth embodiment described above.

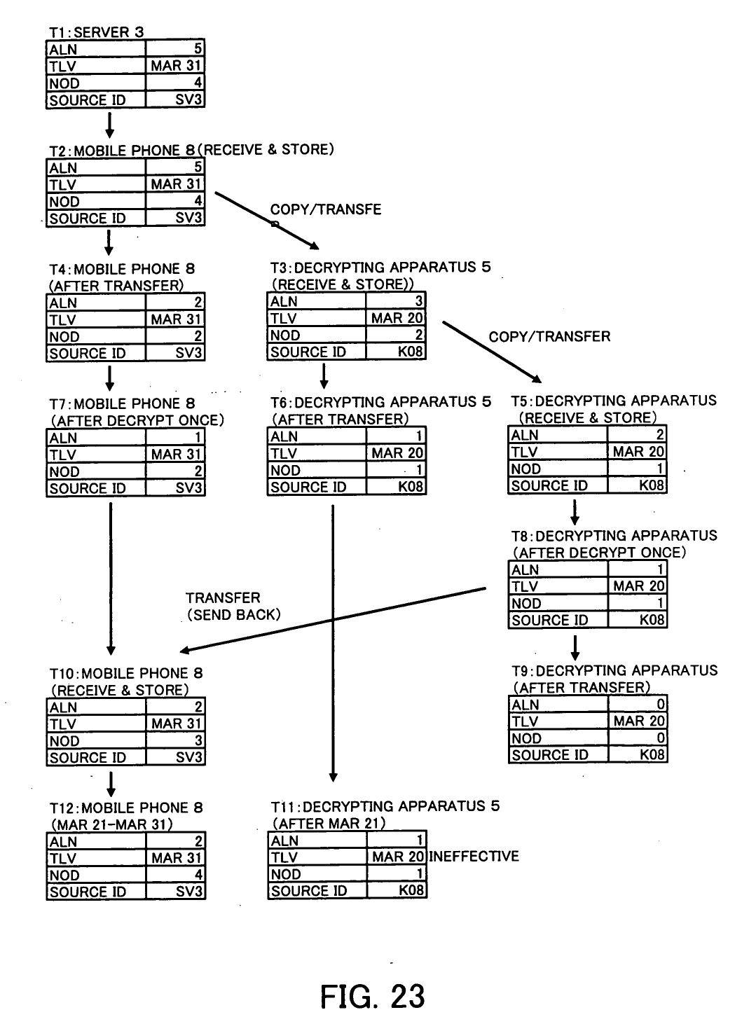

A series of transition of an RTP data block in the fourth embodiment will be described with reference to FIG. 23. The server 3 holds an RTP data block including an ALN of five, a TLV of March 31, an NOD of four and a source ID of “SV3” (table T1). The mobile phone 8 receives the above RTP data block to store in the memory 41 (table T2).

The mobile phone 8 copies the RTP data block and replaces the ALN by three, the TLV by March 20, the NOD by two and the source ID by “K08” that is a self ID of the mobile phone 8, to transfer to the content decrypting apparatus 5. The content decrypting apparatus 5 receives the transferred RTP data block to store in an internal memory (table T3). The ALN of the RTP data block stored in the memory 41 of the mobile phone 8 is reduced by three to be two, and the NOD of the RTP data block stored in the memory 41 of the mobile phone 8 is reduced by two to be two (table T4).

The content decrypting apparatus 5 copies the internally stored RTP data block, and replace the ALN by two and the NOD by one to transfer to the content decrypting apparatus 6. The content decrypting apparatus 6 receives the transferred RTP data block to store in an internal memory (table T5). The ALN of the RTP data block stored in the content decrypting apparatus 5 is reduced by two to be one. The NOD of the RTP data block stored in the content decrypting apparatus 5 is reduced by one to be one (table T6).

Meanwhile, the mobile phone 8 once decrypts a piece of encrypted content with the RTP data block stored in the memory 41. The ALN of the RTP data block stored in the memory 41 is reduced by one to be one (table T7). The content decrypting apparatus 6 once decrypts the encrypted content with the internally stored RTP data block. The ALN of the RTP data block of the content decrypting apparatus 6 is reduced by one to be one (table T8).

The content decrypting apparatus 6 copies the internally stored RTP data block as it is to transfer (send back) to the mobile phone 8. The ALN and the NOD of the RTP data block stored in the content decrypting apparatus 6 each are changed to be zero, i.e. equivalent to deletion of the RTP data block (table T9). The mobile phone 8 receives the RTP data block that has been sent back and checks that the source ID of the received RTP data block equals the self ID of the mobile phone 8. The ALN of the RTP data block stored in the memory 41 is increased by the ALN value that has been sent back to be two, and the NOD of the RTP data block stored in the memory 41 is increased by the NOD value that has been sent back to be three (table T10).

After a date and time indicated by an internal clock of the content decrypting apparatus 5 passes the date of the TLV, March 20, the RTP data block stored in the content decrypting apparatus 5 becomes ineffective (table T11). The mobile phone 8 changes the NOD of the RTP data block stored in the memory 41 to the initial value, four (table T11).

According to the fourth embodiment of the present invention described above, a content decrypting apparatus may retrieve an RTP data block transferred to and sent back from another content decrypting apparatus after checking that a source ID of the RTP data block equals an own self ID.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A content decrypting apparatus capable of decrypting a piece of content stored in a storage medium using a data block representing a right to decrypt the content, comprising:
a communication circuit configured to request and receive the data block, and to receive a request for a data block transfer, the data block including a bunch of distributed keys and an allowed number of times of decryption;
a memory configured to store a bunch of secret keys and the data block;
a media reader configured to read a set of title keys and the content from the storage medium;
a first controller configured, upon being instructed to decrypt the content, to decrypt one of the title keys with one of the distributed keys and one of the secret keys, and to decrypt the content with the decrypted title key; and
a second controller configured, in response to the request for a data block transfer, to produce a secondary data block by copying the data block stored in the memory, to move at least a portion of the allowed number of times of decryption to the secondary data block, and to transfer the secondary data block via the communication circuit.

2. A content decrypting apparatus capable of decrypting a piece of content stored in a storage medium using a data block representing a right to decrypt the content, comprising:
a communication circuit configured to request and receive the data block, and to receive a request for a data block transfer, the data block including a bunch of distributed keys and an allowed number of times of decryption;
a memory configured to store a device identifier, a bunch of secret keys and the data block;
a media reader configured to read a medium identifier, a set of title keys and the content from the storage medium, each of the title keys being encrypted with one of the distributed keys and one of the secret keys, and the content being encrypted with one of the title keys;
a first controller configured, upon being instructed to decrypt the content, to identify one of the distributed keys corresponding to the device identifier, to identify one of the secret keys corresponding to the medium identifier, to decrypt one of the title keys with the identified distributed key and the identified secret key, and to decrypt the content with the decrypted title key in a case where the allowed number of times of decryption is no less than one;
a second controller configured, in response to the request for a data block transfer, to produce a secondary data block by copying the data block stored in the memory and giving a secondary allowed number of times of decryption, and to transfer the secondary data block via the communication circuit, in a case where the allowed number of times of decryption is no less than one; and
a third controller configured to reduce the allowed number of times of decryption of the data block stored in the memory by one each time the content is decrypted, and by the secondary allowed number of times of decryption each time the secondary data block is produced.

3. The content decrypting apparatus of claim 2, further comprising a clock device indicating a date and time, wherein
the first controller is configured to decrypt the content with the decrypted title key, in a case where the allowed number of times is no less than one, where the data block further includes a time limit of validity and where the date and time indicated by the clock device is before the time limit of validity, and
the second controller is further configured to give the secondary data block a secondary time limit of validity.

4. The content decrypting apparatus of claim 2, wherein
the first controller is configured to decrypt the content in a case where the allowed number of times is no less than one and the data block further includes a number of dissemination no less than one,
the second controller is further configured to give the secondary data block a secondary number of dissemination being no greater than the number of dissemination, and
the third controller is further configured to reduce the number of dissemination of the data block stored in the memory by the secondary number of dissemination each time the secondary data block is produced.

5. The content decrypting apparatus of claim 2, wherein
the memory is further configured to store a self identifier in a case where the data block further includes a source identifier of one of a first kind and a second kind, the self identifier being of the second kind,
the second controller is further configured to replace the source identifier of the secondary data block by the self identifier in a case where the source identifier of the data block stored in the memory is of the first kind, and
the third controller is further configured to increase the allowed number of times of decryption of the data block stored in the memory by an allowed number of times of decryption of a data block received after the data block transfer, in a case where the data block received after the data block transfer includes a source identifier equal to the self identifier.

6. The content decrypting apparatus of claim 2, wherein
the memory is further configured to store a self identifier in a case where the data block further includes a number of dissemination and a source identifier of one of a first kind and a second kind, the self identifier being of the second kind,
the first controller is configured to decrypt the content, in a case where the allowed number of times of decryption is no less than one and the number of dissemination is no less than one, the second controller is further configured to give the secondary data block a secondary number of dissemination being no greater than the number of dissemination, and to replace the source identifier of the secondary data block by the self identifier in a case where the source identifier of the data block stored in the memory is of the first kind, and
the third controller is further configured to reduce the number of dissemination of the data block stored in the memory by the secondary number of dissemination each time the secondary data block is produced, and to increase the allowed number of times of decryption and the number of dissemination of the data block stored in the memory by an allowed number of times of decryption and a number of dissemination of a data block received after the data block transfer, respectively, in a case where the data block received after the data block transfer includes a source identifier equal to the self identifier.

7. The content decrypting apparatus of claim 2, further comprising a clock device indicating a date and time, wherein
the first controller is configured to decrypt the content in a case where the allowed number of times is no less than one, where the data block further includes a time limit of validity and a number of dissemination no less than one, and where the date and time indicated by the clock device is before the time limit of validity,
the second controller is further configured to give the secondary data block a secondary time limit of validity and a secondary number of dissemination being no greater than the number of dissemination, and
the third controller is further configured to reduce the number of dissemination of the data block stored in the memory by the secondary number of dissemination each time the secondary data block is produced.

8. The content decrypting apparatus of claim 2, further comprising a clock device indicating a date and time, wherein
the memory is further configured to store a self identifier in a case where the data block further includes a time limit of validity and a source identifier of one of a first kind and a second kind, the self identifier being of the second kind, the first controller is configured to decrypt the content, in a case where the allowed number of times is no less than one and the date and time indicated by the clock device is before the time limit of validity,
the second controller is further configured to give the secondary data block a secondary time limit of validity, and to replace the source identifier of the secondary data block by the self identifier in a case where the source identifier of the data block stored in the memory is of the first kind, and
the third controller is further configured to increase the allowed number of times of decryption of the data block stored in the memory by an allowed number of times of decryption of a data block received after the data block transfer, in a case where the data block received after the data block transfer includes a source identifier equal to the self identifier.

9. The content decrypting apparatus of claim 2, further comprising a clock device indicating a date and time, wherein
the memory is further configured to store a self identifier in a case where the data block further includes a time limit of validity, a number of dissemination and a source identifier of one of a first kind and a second kind, the self identifier being of the second kind,
the first controller is configured to decrypt the content, in a case where the allowed number of times is no less than one, where the number of dissemination is no less than one and where the date and time indicated by the clock device is before the time limit of validity,
the second controller is further configured to give the secondary data block a secondary time limit of validity and a secondary number of dissemination being no greater than the number of dissemination, and to replace the source identifier of the secondary data block by the self identifier in a case where the source identifier of the data block stored in the memory is of the first kind, and
the third controller is further configured to reduce the number of dissemination of the data block stored in the memory by the secondary number of dissemination each time the secondary data block is produced, and to increase the allowed number of times of decryption and the number of dissemination of the data block stored in the memory by an allowed number of times of decryption and a number of dissemination of a data block received after the data block transfer, respectively, in a case where the data block received after the data block transfer includes a source identifier equal to the self identifier.

10. The content decrypting apparatus of claim 7, wherein the third controller is further configured to increase the number of dissemination of the data block stored in the memory by the secondary number of dissemination after the date and time indicated by the clock device passes the secondary time limit of validity.

11. The content decrypting apparatus of claim 9, wherein the third controller is further configured to increase the number of dissemination of the data block stored in the memory by the secondary number of dissemination after the date and time indicated by the clock device passes the secondary time limit of validity.

12. The content decrypting apparatus of claim 2, further comprising a clock device indicating a date and time, wherein
the communication circuit is further configured to send and receive a date and time with a first external apparatus and with a second external apparatus, and
the first controller is further configured to decrypt a date and time received from the first external apparatus with the date and time indicated by the clock device in a case where the clock device and the first external apparatus synchronize with each other, and to encrypt the secondary data block with the date and time indicated by the clock device in a case where the clock device and the second external apparatus synchronize with each other.

13. A method for using and transferring a data block representing a right to decrypt a piece of content stored in a storage medium, comprising:
receiving the data block including a bunch of distributed keys and an allowed number of times of decryption after requesting the data block;
storing the data block in a memory with a bunch of secret keys;
reading a set of title keys and the content from the storage media;
decrypting one of the title keys with one of the distributed keys and one of the secret keys;
producing a secondary data block by copying the data block stored in the memory after receiving a request for a data block transfer;
moving at least a portion of the allowed number of times of decryption to the secondary data block; and
transferring the secondary data block.
